(19) United States
(12) Patent Application Publication
(10) Pub. No.: US 2026/0281233 A1
(43) Pub. Date: Sep. 17, 2026

(54) SYSTEM

(71) Applicant: SoftBank Group Corp., Tokyo (JP)

(72) Inventor: Hidenori OHTA, Tokyo (JP)

(73) Assignee: SoftBank Group Corp., Tokyo (JP)

(21) Appl. No.: 19/546,479

(22) Filed: Feb. 23, 2026

Related U.S. Application Data
(60) Provisional application No. 63/772,128, filed on Mar. 14, 2025.

(51) Int. Cl. H04M 3/22; G10L 25/30

(52) U.S. Cl. CPC H04M 3/2281; G10L 25/30; H04M 2203/6027

(57) ABSTRACT

A system includes a processor that is configured to convert, by an audio recognition unit, an audio signal received via a telephone line into digital data and convert the digital data into text data, analyze, by a natural language processing unit, the text data generated by the audio recognition unit and generate a summary of a conversation, compare, by a fraud determination unit, the summary generated by the natural language processing unit with predetermined fraud determination conditions and determine a possibility of fraud, and issue, by a warning notification unit, a warning to a user when the fraud determination unit determines that there is the possibility of fraud, and transmit a notification to a registered related person when necessary.

### CROSS-REFERENCE TO RELATED APPLICATION

This application claims the benefit of U.S. Provisional Application No. 63/772,128, filed on Mar. 14, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional telephone systems do not provide sufficient real-time protection against fraudulent calls, particularly for vulnerable users such as elderly persons, who are often targeted by sophisticated social engineering schemes. In many cases, a caller induces the user to perform an urgent money transfer, change a transfer destination to an unknown bank account, or disclose sensitive personal information, by exploiting psychological pressure, urgency, or confusion. Existing caller identification or simple blacklist approaches are inadequate because fraudsters frequently change phone numbers and adapt their scripts, and such approaches do not analyze the actual content of the conversation. Furthermore, known systems rarely integrate end-to-end processing from audio capture, through natural language understanding and fraud risk assessment, to immediate warning and automatic notification of trusted third parties. As a result, users may not recognize that a call is fraudulent until after financial damage has occurred, and family members or security organizations are often informed too late to intervene effectively. Therefore, there is a need for a system that can, during an ongoing telephone call, automatically convert call audio to text, analyze the content and context of the conversation, determine the possibility of fraud based on predetermined and dynamically updated conditions, and promptly warn the user and related persons in order to prevent or mitigate damage from fraudulent calls.

### SUMMARY

In order to solve the above-described problems, a system is provided that comprises a processor configured to perform integrated audio recognition, natural language processing, fraud determination, and warning notification during a telephone call. The processor is configured to convert, by an audio recognition unit, an audio signal received via a telephone line into digital data and convert the digital data into text data. The processor is further configured to analyze, by a natural language processing unit, the text data generated by the audio recognition unit and generate a summary of a conversation, for example by identifying important words including at least nouns and verbs and analyzing relationships among the important words. The processor is configured to compare, by a fraud determination unit, the summary generated by the natural language processing unit with predetermined fraud determination conditions and determine a possibility of fraud. The processor may use a machine learning algorithm to learn new patterns from past fraud cases and update the fraud determination conditions, thereby enabling adaptation to evolving fraud schemes. When the fraud determination unit determines that there is the possibility of fraud, the processor is configured to issue, by a warning notification unit, a warning to a user, for example by displaying a message on a display of a telephone and prompting caution by voice, and to transmit a notification to at least one of family members, friends, and a security organization registered in advance by the user, the notification including at least one of the summary of the conversation for which there is the possibility of fraud and instructions for an emergency contact. The processor may be incorporated directly into a telephone, or may cooperate with a dedicated hardware device installed for an existing fixed telephone, the dedicated hardware device being connected to a telephone line, processing audio data in real time, being connected to the Internet, and operating in conjunction with a cloud-based audio recognition service and a cloud-based natural language processing service, thereby enabling deployment in both new and legacy telephone environments.

The term “system” refers to an integrated combination of hardware, software, and communication components that collectively implement the functions recited in the claims, including audio recognition, natural language processing, fraud determination, and warning notification.

The term “processor” refers to any electronic data processing device, or combination of devices, capable of executing instructions to perform the claimed functions, including but not limited to a microprocessor, a microcontroller, a digital signal processor (DSP), a field-programmable gate array (FPGA), an application-specific integrated circuit (ASIC), or a distributed set of such elements.

The term “audio recognition unit” refers to a functional module implemented by the processor, alone or in combination with dedicated hardware, that receives an audio signal, converts the audio signal into digital data, and converts the digital data into text data using speech recognition techniques.

The term “natural language processing unit” refers to a functional module implemented by the processor that analyzes text data generated by the audio recognition unit, performs at least linguistic and semantic processing, and generates a summary of a conversation based on the analysis.

The term “fraud determination unit” refers to a functional module implemented by the processor that compares a conversation summary generated by the natural language processing unit with predetermined fraud determination conditions and determines a possibility of fraud based on the comparison, optionally using machine learning algorithms. The term “warning notification unit” refers to a functional module implemented by the processor that issues a warning to a user when a possibility of fraud is determined by the fraud determination unit and transmits a notification to at least one registered related person when necessary.

The term “audio signal” refers to an analog or digital representation of sound, including at least the speech of one or more participants in a telephone call, received via a telephone line or equivalent communication interface.

The term “digital data” refers to a representation of information, including audio samples, in a discrete, machine-readable format that can be processed by the processor or related digital circuitry.

The term “text data” refers to a digital representation of linguistic content obtained by converting audio data into written or symbolic form, such as characters, words, or tokens, suitable for processing by the natural language processing unit.

The term “summary of a conversation” refers to a condensed textual representation that captures essential content, topics, and relationships from a longer conversation, including at least information relevant to money transfers, account changes, or other potentially fraudulent requests.

The term “predetermined fraud determination conditions” refers to one or more rules, patterns, thresholds, or models, defined in advance or updated over time, that are used by the fraud determination unit to assess whether a conversation is likely to be fraudulent.

The term “possibility of fraud” refers to a state or evaluation indicating that a conversation meets or exceeds at least one of the predetermined fraud determination conditions to a degree sufficient to warrant a warning or notification.

The term “noise reduction technique” refers to any algorithm or signal processing method that suppresses or attenuates background noise, echo, or other unwanted audio components to improve the clarity of a speaker's voice.

The term “important words” refers to words that are determined by the natural language processing unit to be semantically or contextually significant to understanding the conversation, including at least nouns and verbs related to transactions, amounts, accounts, or urgent actions.

The term “registered related person” refers to any person or organization whose contact information is pre-stored in association with a user account or device configuration, including at least family members, friends, or security organizations, to whom notifications may be automatically transmitted.

The term “notification” refers to information transmitted by the warning notification unit to a registered related person, including at least a warning about a suspected fraudulent call, a summary of the conversation, and optionally instructions for emergency contact or intervention.

The term “telephone” refers to any device configured to perform voice communication over a wired or wireless network, including a fixed-line phone, a mobile phone, or an IP phone, and capable of being coupled with the system or incorporating the system's processor.

The term “dedicated hardware device” refers to a physical device separate from an existing telephone, configured to connect to a telephone line, process audio data in real time, communicate with external services via a network, and cooperate with the processor to perform one or more functions of the claimed system.

The term “cloud-based audio recognition service” refers to a remotely located speech recognition service accessible over a network, in which server-side processing resources execute algorithms to convert audio data received from the system into text data.

The term “cloud-based natural language processing service” refers to a remotely located service accessible over a network, in which server-side processing resources execute natural language processing algorithms to analyze text data and generate outputs such as conversation summaries or extracted features.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

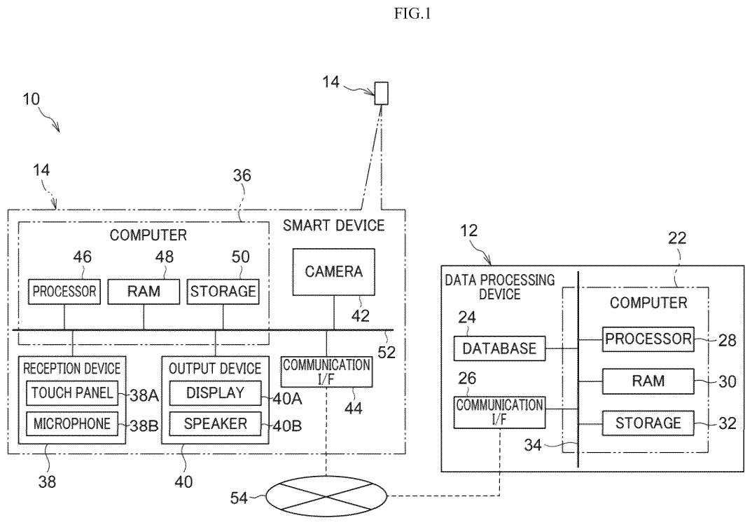

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

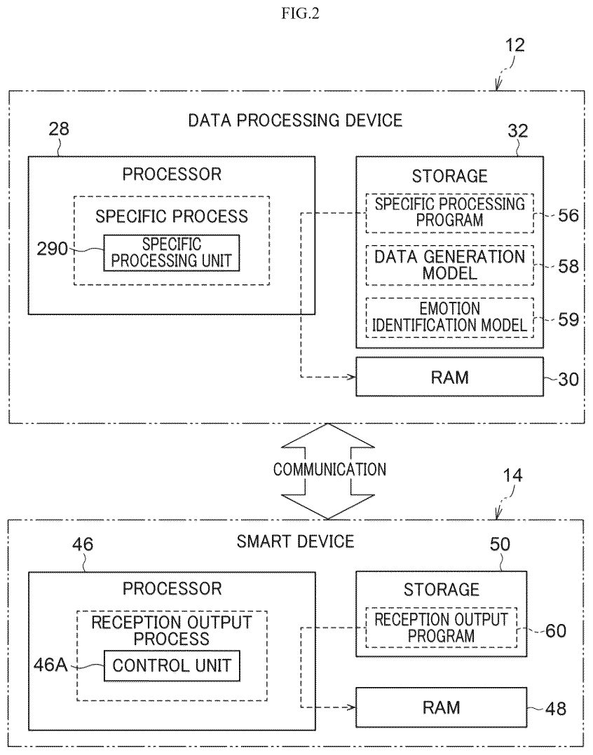

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for detecting fraudulent telephone calls typically rely on static keyword lists, manually designed rules, or standalone machine learning models that operate on pre-collected text data. Such systems suffer from several technical limitations at the level of computer architecture and information processing. First, because audio acquisition, speech recognition, text analysis, risk scoring, and user notification are often implemented as loosely coupled components, these systems exhibit high processing latency and unstable behavior when handling streaming voice data in real time. This results in delayed or missed warnings to users during ongoing calls. Second, existing systems generally treat automatic speech recognition output as final and do not apply adaptive correction in the processing pipeline, causing error propagation from noisy audio and misrecognized text into subsequent natural language analysis and fraud-risk determination. As a result, the accuracy of fraud detection deteriorates in the presence of background noise, accents, or atypical phrasing. Third, conventional architectures typically use fixed fraud-determination rules and static models that are updated infrequently by manual engineering. Such systems are unable to ingest unstructured descriptions of new fraud methods from external information sources efficiently, and therefore they cannot timely update internal rule sets and model features, which leads to a persistent gap between emerging fraud patterns and detection capabilities. Fourth, existing user-notification mechanisms are often limited to simple alerts on a single device and do not exploit structured representations and real-time risk scores to coordinate notifications to related parties across heterogeneous communication services, thereby reducing the effectiveness of intervention when a high-risk call is underway. Fifth, feedback from end users about whether a given call was actually fraudulent is rarely integrated into the model-update loop in a structured manner, so that the underlying determination models cannot systematically improve their performance over time based on labeled interaction data. Accordingly, there is a need for a technical solution that improves the operation of computer systems for real-time fraud detection on telephone calls by tightly integrating audio signal processing, streaming automatic speech recognition, natural language understanding, fraud-risk evaluation, and multi-endpoint notification under unified control. There is a further need for a mechanism that uses a generative AI model, driven by dynamically constructed prompt sentences, as an internal processing engine to correct recognition output, generate structured and summarized representations, produce human-readable explanations of risk, and synthesize new detection rules from unstructured external descriptions of fraud methods. Such a solution should reduce processing latency, increase robustness to noise and linguistic variation, adapt detection logic to evolving fraud tactics, and enhance the overall reliability and responsiveness of the computer system.

The specific processing by the specific processing unit 290 of the data processing device 12 in Example 1 is realized by the following means.

The present invention provides a server comprising a processor configured to acquire and preprocess call voice signals from a communication device, convert the preprocessed call voice signals into text information in a streaming manner, analyze the text information to generate structured information and summary information, determine a fraud risk based on the structured information and the summary information, generate warning information based on the fraud risk, generate prompt sentences for a generative AI model using at least one of the text information, the structured information, and the summary information as input, cause the generative AI model to perform at least one of correction of the text information, generation of the structured information, generation of the summary information, generation of explanation information regarding the fraud risk, and generation of the warning information, and control, in real time, exchange of the call voice signals, the text information, the structured information, the summary information, and the fraud risk among functional units in the system. This enables improvement of computer operation for real-time fraud detection on telephone calls by reducing end-to-end processing latency, mitigating error propagation from noisy audio and misrecognition, adaptively updating fraud-detection behavior via generative-model-based rule synthesis, and providing coordinated, multi-endpoint warning and notification actions based on dynamically computed risk assessments.

The term “call voice signal” refers to an analog or digital audio signal representing spoken communication in a telecommunication session, including speech from at least one participant of a telephone call.

The term “preprocess” refers to performing one or more signal-processing or data-processing operations on raw input data, such as filtering, noise reduction, reverberation suppression, or normalization, before subsequent analysis or conversion.

The term “text information” refers to character-based data obtained by converting a call voice signal into a sequence of textual symbols representing recognized words, phrases, or sentences.

The term “structured information” refers to data that represents the content of text information in a machine-readable format with explicit fields or attributes, including at least entities, categories, or relationships extracted from the text information.

The term “summary information” refers to data representing a condensed description of a longer conversation, in which essential facts, events, or conditions are preserved while less important details are omitted.

The term “fraud risk” refers to an indication of a likelihood that a given call or conversation includes fraudulent content, the indication being expressed as a score, probability, or category derived from analysis of text information or structured information.

The term “warning information” refers to data representing an alert or notification intended to inform a user or another party about a detected fraud risk, including at least a warning message and optionally an explanation of the risk.

The term “notification information” refers to data transmitted to a related-party terminal or service that indicates a detected fraud risk and includes at least summary information, risk-related information, and optionally recommended actions.

The term “user terminal” refers to an information processing apparatus operated by a primary user, capable of sending or receiving call voice signals and of presenting warning information.

The term “registered related-party terminal” refers to an information processing apparatus associated with a person or organization designated in advance by a user, to which notification information is transmitted when a fraud risk is detected.

The term “functional unit” refers to a hardware component, software module, or logical subsystem configured to perform a specific processing function within the system, such as audio processing, speech recognition, text analysis, risk evaluation, or notification control. The term “real time” refers to processing and communication performed with latency sufficiently low that outputs, including fraud risk determination and warning information, are generated while a corresponding telephone call is still ongoing.

The term “noise reduction processing” refers to signal-processing operations that reduce or remove unwanted background components from a call voice signal, including at least stationary noise, transient noise, or interference.

The term “reverberation suppression processing” refers to signal-processing operations that reduce effects of echoes or reverberation in a call voice signal to improve clarity of the speaker's voice.

The term “volume normalization processing” refers to signal-processing operations that adjust amplitude levels of a call voice signal to maintain the speaker's voice within a desired loudness range.

The term “morphological analysis processing” refers to natural language processing operations that segment text information into tokens and assign grammatical categories such as parts of speech to each token.

The term “syntactic analysis processing” refers to natural language processing operations that determine structural relationships between tokens in text information, including at least dependencies or phrase structures.

The term “sentiment analysis processing” refers to natural language processing operations that estimate an affective state or attitude expressed in text information, including at least polarity or emotional tone.

The term “topic extraction processing” refers to natural language processing operations that identify one or more main themes, subjects, or categories discussed in text information. The term “attribute information” refers to structured information that represents specific properties or elements extracted from text information, including at least monetary request information, payment condition information, transaction party identification information, time information, and participant information.

The term “monetary request information” refers to attribute information indicating that a payment, transfer, or provision of funds is being requested, including at least requested amounts and currencies.

The term “payment condition information” refers to attribute information indicating terms or constraints under which a payment or transfer is requested, including at least deadlines, methods, or destinations.

The term “transaction party identification information” refers to attribute information indicating individuals, entities, or accounts involved or purported to be involved in a monetary transaction.

The term “participant information” refers to attribute information indicating persons or roles participating in a conversation, including at least a caller, a callee, or referenced third parties. The term “rule-based processing” refers to processing that applies one or more predefined conditions, patterns, or logical rules to data to derive a decision, classification, or flag. The term “fraud determination condition” refers to one or more rules, thresholds, patterns, or criteria used to decide whether given data indicates a potential fraudulent activity.

The term “trained determination model” refers to a statistical or machine-learning model whose parameters have been obtained through training on labeled data to output an estimate or classification regarding fraud risk.

The term “risk score” refers to a numeric or ordinal measure output by a trained determination model or a combined evaluation, indicating the degree of fraud risk.

The term “risk category” refers to a discrete classification derived from a risk score or rule-based processing, indicating a level of fraud risk such as low, medium, or high. The term “generative AI model” refers to a machine-learning model configured to generate output data, such as text or structured data, in response to input data, the model having been trained on example data so as to produce contextually relevant sequences.

The term “prompt sentence” refers to text data supplied to a generative AI model as an instruction or query, together with optional additional input data, to control behavior of the generative AI model.

The term “misrecognition correction” refers to processing that modifies text information produced by an automatic recognition mechanism to reduce errors and better reflect content of original speech.

The term “punctuation insertion” refers to processing that adds punctuation marks or formatting to text information to improve readability and reflect sentence boundaries or pauses

The term “explanation information regarding the fraud risk” refers to information describing reasons, contributing factors, or evidence underlying a fraud risk determination, in a form understandable to a human user.

The term “draft warning message” refers to candidate warning information generated for presentation or transmission, which may be directly used or further modified before delivery to a user or related party.

The term “electronic communication service” refers to a communication mechanism that enables transmission of digital messages between devices, including at least email services, messaging services, or short message services.

The term “call time information” refers to temporal information associated with a call, including at least start time, end time, or duration of the call.

The term “recommended action information” refers to information suggesting one or more actions for a user or related party to take in response to a detected fraud risk, such as refraining from payment or confirming via another communication channel.

The term “feedback information” refers to data provided by a user or another party indicating whether a given call or determination result is correct, incorrect, or uncertain with respect to fraud.

The term “learning data” refers to data used to train or update a trained determination model, including at least input features and corresponding labels derived from feedback information or other sources.

The term “external information source” refers to a system, database, or service outside the described system that provides information about fraud methods, patterns, or related security information.

The term “new fraud method” refers to a type of fraudulent behavior or scheme that is not yet fully represented in existing fraud determination conditions or training data.

The term “determination rule information” refers to structured information describing one or more rules, patterns, or conditions used for fraud determination, including at least detection keyword information, typical expression information, and context condition information. The term “detection keyword information” refers to a set of words, phrases, or expressions whose presence in text information is indicative of a particular fraud pattern. The term “typical expression information” refers to representative phrases, sentences, or formulations commonly used in a given fraud method.

The term “context condition information” refers to conditions related to surrounding context, such as co-occurrence of topics, emotional tone, or temporal constraints, that influence interpretation of text information for fraud determination.

In one embodiment, a server and a terminal cooperate to implement the claimed system. The terminal is implemented as a telecommunication device such as a dedicated hardware attachment for a fixed-line telephone or a mobile communication device. The terminal comprises a high-sensitivity microphone, an analog-to-digital converter, a communication interface such as a wireless interface or wired network interface, a speaker, a display, and a processor executing an operating system such as a mobile operating system. The server is implemented as a computer apparatus such as a virtual machine or a physical computer system comprising at least one central processing unit, a memory, a network interface, and a persistent storage device such as a solid-state drive. The server executes a server operating system such as a general-purpose server operating system and runs application software including an application framework, a web server component, and machine learning libraries.

The terminal acquires a call voice signal from a telecommunication line connected to a telephone set or from an internal audio path of the terminal. The terminal uses the high-sensitivity microphone and the analog-to-digital converter to convert an analog call voice signal into digital audio samples, for example, 16 kHz, 16-bit linear pulse code modulation samples. The terminal stores the digital audio samples in a buffer in a main memory and segments the samples into fixed-length frames, for example, frames of 20 milliseconds. The terminal executes noise reduction processing, reverberation suppression processing, and volume normalization processing on each frame using a digital signal processing library, for example, a library corresponding to WebRTC audio processing or an equivalent library. By applying spectral subtraction, Wiener filtering, or minimum mean square error-based methods, the terminal reduces stationary background noise and transient noise. By applying adaptive filter-based echo cancellation and dereverberation methods, the terminal suppresses echoes and reverberation. By applying level detection and gain control, the terminal normalizes an amplitude of the call voice signal. As a result, the terminal outputs a preprocessed digital audio stream with improved signal-to-noise ratio. This preprocessing improves an accuracy of subsequent automatic speech recognition and reduces a need for retransmission or reprocessing, thereby improving processing efficiency and reducing overall latency.

The terminal compresses the preprocessed audio stream using an audio codec such as an implementation corresponding to an Opus codec or an advanced audio codec. The terminal packages compressed audio frames into data packets and transmits the data packets to the server via a secure communication protocol such as a hypertext transfer protocol secure session. The terminal uses a communication stack of the operating system, including a network driver, a transport protocol stack, and a security library implementing a transport layer security protocol. The terminal also transmits metadata such as a call identifier, timestamps, and routing information in header fields of the packets. By streaming compressed audio instead of uncompressed audio, the terminal reduces communication load and allows the system to support a larger number of concurrent calls.

The server receives the compressed audio packets through a network interface and a web server module such as an application implemented using a web framework. The server validates authentication information attached to the packets and associates received packets with a call session object stored in a main memory. The server uses an audio decoding library corresponding to a decoder for the used codec to decode the compressed audio into linear pulse code modulation samples. The server stores decoded audio frames in a ring buffer associated with the call session. The server maintains pointers indicating an amount of audio frames consumed by a speech recognition module and an amount of audio frames written by a decoding module. By using such buffer management, the server supports low-latency streaming recognition and avoids buffer overruns.

The server performs automatic speech recognition on the decoded audio frames. In one embodiment, the server uses a neural network-based automatic speech recognition engine implemented in a machine learning framework such as a framework corresponding to TensorFlow or PyTorch. The server loads an acoustic model comprising multiple layers, for example, a convolutional front-end followed by multiple transformer encoder layers, and a language model, for example, a transformer-based language model or an n-gram language model. The server executes voice activity detection by applying an energy-based or neural network-based classifier to each frame to identify speech and non-speech segments. The server converts sequences of acoustic feature vectors, for example, log-mel filter bank features or mel-frequency cepstral coefficients, into hidden representations using the acoustic model and decodes the hidden representations into character or token sequences using a decoding algorithm such as beam search that considers both the acoustic model scores and the language model scores. The server generates partial text information such as partial transcripts during the call and updates a full transcript maintained in memory.

The server refines the full transcript using a generative AI model. The server uses a generative AI model implemented as a transformer-based sequence-to-sequence neural network or an autoregressive language model, trained on large amounts of text and speech-transcript pairs. The server constructs a prompt sentence for the generative AI model including instructions and the raw transcript. For example, the server generates a prompt sentence such as:

“The following is a raw automatic speech recognition transcript of a telephone conversation. Please correct recognition errors and add appropriate punctuation, keeping the meaning unchanged: [raw transcript].”

The server inputs the prompt sentence and the raw transcript to the generative AI model. The generative AI model outputs corrected text information with improved punctuation and reduced recognition errors. The server replaces or augments the raw transcript with the corrected text information. By using the generative AI model in this manner, the server reduces recognition errors that are difficult to correct by conventional deterministic post-processing rules, thereby improving downstream natural language processing accuracy and lowering an overall false positive and false negative rate of fraud detection.

The server analyzes the corrected text information using a natural language processing pipeline. The server first performs language detection, for example, by using character distribution and simple classifier models. The server then applies a tokenizer appropriate for a detected language. For a language that requires morphological analysis, the server uses a morphological analyzer corresponding to a library such as MeCab or Sudachi to segment text into tokens and assign part-of-speech tags. The server uses a syntactic analysis module corresponding to a dependency parser, for example, an implementation similar to a parser provided by spaCy or a comparable library, to determine dependency relations between tokens. The server uses a named entity recognition model, for example, a neural network using bidirectional long short-term memory layers and a conditional random field layer, or a transformer-based token classifier, to extract entities such as person references, organization references, financial institution references, monetary amounts, and time expressions. The server performs sentiment analysis using a classifier built on a neural network architecture, for example, a transformer encoder fine-tuned for sentiment classification, to assign categories such as “urgent”, “fearful”, or “neutral” to segments of the conversation. The server further classifies topics in the conversation using a topic classification model, for example, a neural network trained to output categories such as “bank transfer”, “accident involving relative”, “tax refund”, or “technical support”. The server aggregates these outputs into structured information that includes attribute information such as monetary request information, payment condition information, transaction party identification information, time information, and participant information.

In addition, the server uses a generative AI model to generate structured information in a flexible schema. The server constructs a prompt sentence that instructs the model to output structured information, for example:

“Analyze the following telephone conversation transcript. Extract key entities (people, banks, account numbers, amounts, deadlines) and label each utterance by topic and emotional tone. Output the result as a structured description in plain text. Transcript: [corrected transcript].” The server inputs this prompt sentence and the corrected transcript into the generative AI model and receives a response describing entities, topics, and emotions. The server post-processes the response and maps described elements into internal data structures such as key-value pairs and lists stored in a relational database or a document-oriented database. This combination of rule-based natural language processing and generative AI-based extraction uses complementary strengths: symbolic parsers provide consistency for well-defined patterns, while the generative AI model generalizes to new phrasing. As a result, the server obtains robust structured information from diverse and noisy telephone conversations. The server generates summary information from the corrected text information and the structured information. In one embodiment, the server uses a scoring algorithm such as a TextRank algorithm applied to a sentence graph, where nodes represent sentences and edges represent similarity based on term frequency-inverse document frequency vectors. The server selects sentences with high scores and then applies a generative AI model to rewrite and compress the selected content. The server constructs a prompt sentence such as:

“Summarize the following telephone conversation in 3-5 sentences, focusing on who is asking for money, the reason for the payment, the amount, and the bank account details. Use neutral language and do not omit any financial conditions. Conversation: [conversation text or extracted segments].”

The server uses the generative AI model to produce summary information that emphasizes financial transactions and constraints. By using summary information, the server reduces the amount of text that must be processed by subsequent fraud determination logic and transmitted to terminals, thereby improving computational efficiency and reducing communication load.

The server determines a fraud risk using a combination of rule-based processing and a trained determination model. The server stores fraud determination conditions as a set of rules in a rule engine. Each rule may specify conditions on structured information and summary information, such as: presence of an urgent monetary request above a threshold amount; reference to a new or unknown financial account; combination of an “accident” topic and a monetary transfer request; or mismatch between claimed identity and caller identification data. The server evaluates these rules on the structured information and summary information. If a rule is satisfied, the server sets corresponding risk flags and partial scores.

In parallel, the server computes a feature vector for a trained determination model. The feature vector can include binary indicators for presence of specific high-risk keywords, counts of references to financial accounts, numeric values of requested amounts, normalized against typical spending patterns, topic probabilities from a topic classifier, sentiment categories such as “urgent” or “fearful”, and statistics related to call duration or position of monetary requests in the conversation. The server inputs the feature vector into a trained model such as a gradient boosting machine, a random forest, or a neural network classifier comprising multiple fully connected layers with rectified linear unit activations and a final sigmoid output. The model has been trained on labeled historical call data where each call is labeled as fraudulent or non-fraudulent. During training, the server applied a loss function such as a binary cross-entropy loss and updated model parameters through gradient-based optimization such as stochastic gradient descent or an adaptive learning rate method. In some embodiments, the server performs data augmentation by simulating noise in transcripts and adding paraphrased versions to increase robustness.

The server combines outputs from the rule-based processing and the trained determination model. For example, the server calculates a combined risk score by applying a weighted sum or another combination function, where weights are tuned based on validation data. The server maps the combined risk score into a risk category such as “low”, “medium”, or “high” according to configurable thresholds stored in configuration data. This mapping provides an interpretable classification of fraud risk for downstream modules.

To make the fraud determination more transparent, the server uses a generative AI model to generate explanation information regarding the fraud risk. The server constructs a prompt sentence such as:

“Given the following conversation summary, structured attributes, and risk features, explain in plain language why this call is likely or unlikely to be a telephone scam. Highlight specific phrases, amounts, and patterns that contributed to the decision. Data: [summary, structured attributes, risk score, triggered rules].”

The server inputs this prompt sentence and the underlying data into the generative AI model and receives explanation information that describes the rationale for the risk classification. The server may log this explanation information and provide it to the user terminal or to a related-party terminal in case of dispute or review. By generating explanation information in this manner, the system improves transparency for human users without requiring manual rule annotation.

The terminal receives fraud risk information and associated warning information from the server over the network. The terminal uses its display to present a warning message such as “This call may be a scam. Please do not transfer money.” The terminal uses its text-to-speech engine, implemented by a text-to-speech library provided by the operating system or an external library, to output a spoken warning through the speaker. For example, the terminal may cause the text-to-speech engine to synthesize a message such as “Warning. This phone call may be a scam. Please hang up and verify the situation with your family.” The terminal determines whether to interrupt the call audio or to mix the warning voice into the call audio based on a configuration and a risk category. By providing audible warnings during a call, the system helps protect users who may have difficulty reading the display.

When the fraud risk satisfies a configured threshold, the server transmits notification information to one or more registered related-party terminals via electronic communication services. The server composes a notification message including call time information, summary information, the risk category, and recommended action information, such as “Please contact the user on a separate trusted channel and advise the user not to make any transfer until verification.” The server sends the notification message via an email protocol using a mail transfer agent or via a messaging service interface. The terminal or another client device operated by a related party receives and displays the notification. By distributing structured notification information across multiple endpoints, the system allows timely intervention by trusted contacts, which is not achievable by a single local alert alone. The server collects feedback information from the user terminal. After a call or when a warning is presented, the terminal displays user interface controls that allow the user to indicate whether the call was actually fraudulent, non-fraudulent, or unknown. The terminal transmits such feedback information to the server with a call identifier. The server stores this feedback information in association with call data and uses the feedback information as learning data for retraining or fine-tuning the trained determination model. For example, the server may periodically retrain the model on a combined dataset including prior training data and newly collected labeled examples, using the same or improved loss function and optimization settings. By incorporating feedback information into training, the system gradually adapts to new patterns and reduces misclassification rates.

The server also uses the generative AI model to update fraud determination conditions when new fraud methods emerge. The server acquires explanation information regarding new fraud methods from an external information source, such as textual advisories published by financial institutions or security organizations. The server constructs a prompt sentence such as:

“Convert the following description of a new telephone scam method into a set of detection rules and example phrases. Output detection keywords, typical expressions, and contextual clues in plain text. Description: [external advisory text].”

The server inputs the description and the prompt sentence into the generative AI model. The model outputs candidate detection keyword information, typical expression information, and context condition information. The server parses the output and converts it into determination rule information compatible with its internal rule engine, for example, by creating rule templates that trigger when combinations of extracted keywords and context conditions are observed. The server merges the new rules with existing rules and updates a configuration of the rule engine. This process allows the server to use the generative AI model not just as a classifier, but as a tool for synthesizing and updating detection logic in a way that would be prohibitively time-consuming for human engineers, thereby improving responsiveness to evolving fraud techniques.

In another embodiment, the server and the terminal are integrated into a single device installed between a fixed-line telephone and a telecommunication network. In this case, the device includes both audio acquisition components and processing components described above. The device still performs the same sequence of preprocessing, recognition, analysis, risk determination, and warning, but with some functions running fully on-device and others running on a remote server. For example, for bandwidth-limited environments, the device may perform local automatic speech recognition using a compressed neural network suitable for execution on an embedded processor, such as a smaller transformer model quantized to a lower precision. In this variation, the device transmits text information instead of audio to the server, thereby reducing communication load further.

In yet another embodiment, the server uses different model architectures. For instance, instead of a transformer-based generative AI model, the server may use a recurrent neural network with attention, or a mixture-of-experts architecture where multiple sub-models specialize in different domains such as financial scams, technical support scams, and tax-related scams. The server may also adjust hyperparameters such as beam width in decoding, attention window size, and sequence length limits to balance latency and accuracy. The ability to configure these parameters demonstrates that the system is not merely implementing an abstract idea, but is optimizing concrete computational behavior for specific technical constraints.

Because the server and the terminal jointly perform optimized signal processing, streaming decoding, and multi-stage natural language understanding that is tightly integrated with generative AI-assisted correction and rule synthesis, the system improves computer technology itself. The system reduces an end-to-end delay from audio capture to risk notification by using streaming buffers, efficient codecs, and incremental decoding. The system improves accuracy by combining deep neural acoustic and language models, noise-robust preprocessing, contextual natural language analysis, and feedback-driven model updates. The system improves computational efficiency and communication efficiency by generating summary information and transmitting only condensed representations when possible. The system also improves system manageability by automatically converting unstructured descriptions of new fraud methods into structured rules, reducing manual engineering effort and decreasing the window of vulnerability to novel scams.

The server uses these techniques not merely to automate human judgment, but to perform operations that are beyond practical human capabilities, such as real-time, frame-level audio enhancement, millisecond-level buffering, multi-dimensional feature extraction from large text streams, and continuous model adaptation using high-dimensional feature vectors and gradient-based optimization. The specific combination of noise reduction, transformer-based automatic speech recognition, structured feature extraction, hybrid rule and model-based risk scoring, and generative AI-based prompt-driven processing results in measurable technical effects, including higher detection accuracy, lower latency, reduced false alarms, and improved robustness against noisy conditions and linguistic diversity. Through these technical configurations, the invention provides an improved computer system for real-time fraud detection and user protection in telecommunication environments.

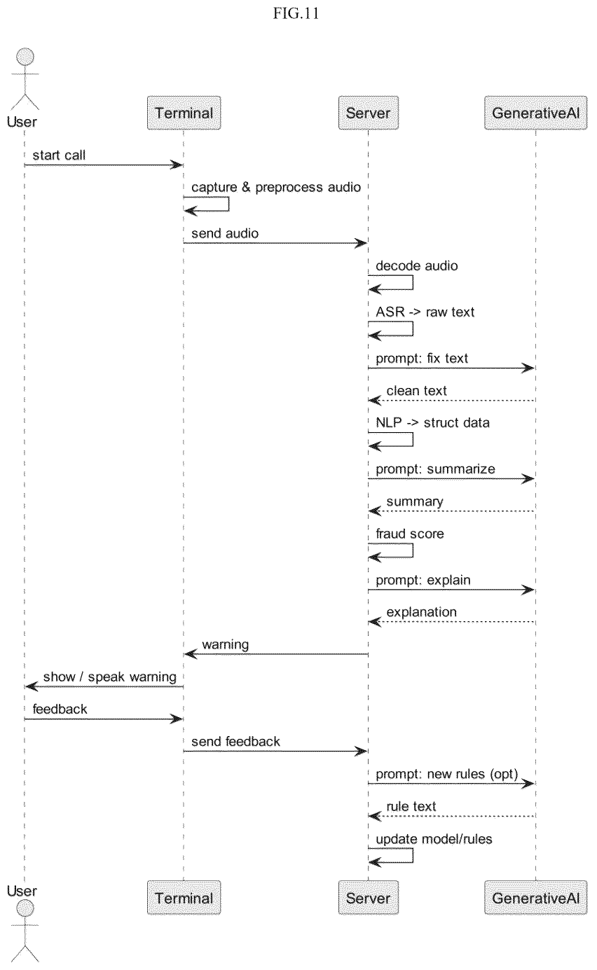

The following describes the processing flow using FIG. 11.

### Step 1:

The terminal acquires a call voice signal from a telephone line as an analog input and outputs digitized audio frames.

The terminal uses a high-sensitivity microphone and an analog-to-digital converter to sample the analog call voice signal at a fixed sampling rate, for example 16 kHz, and a fixed bit depth, for example 16 bits. The terminal stores the resulting linear pulse code modulation samples into a circular buffer in main memory. The input of this step is the analog call voice signal arriving from the telephone network, and the output of this step is a stream of digital audio frames of fixed length, each frame containing a sequence of samples ready for further processing.

### Step 2:

The terminal preprocesses the digital audio frames and outputs noise-reduced, normalized audio frames.

The terminal reads raw audio frames from the circular buffer and applies digital signal processing operations such as noise reduction, reverberation suppression, and volume normalization. The terminal uses a signal processing library, for example a library corresponding to a WebRTC audio processing module, to compute spectral features of each frame, estimate background noise statistics, and subtract or attenuate noise components. The terminal uses adaptive filters to cancel echoes and reverberation and applies automatic gain control to normalize amplitude levels. The input of this step is the raw digital audio frames from Step 1, and the output of this step is a stream of enhanced audio frames with reduced noise and stabilized volume, suitable for accurate speech recognition.

### Step 3:

The terminal compresses the enhanced audio frames and transmits compressed packets to the server.

The terminal encodes the enhanced audio frames using an audio codec such as an implementation equivalent to an Opus codec or an advanced audio codec. The terminal groups encoded frames into packets, appends metadata such as a call identifier and sequence numbers, and encrypts the packets using a secure transport protocol implemented by a security library. The terminal sends the encrypted packets over a network interface using a protocol such as HTTPS. The input of this step is the enhanced audio frame stream from Step 2, and the output of this step is a time-ordered sequence of compressed, encrypted packets delivered to the server.

### Step 4:

The server receives and decodes the compressed audio packets and outputs reconstructed audio frames.

The server accepts incoming packets at a network interface and passes them to an application server implemented using a web framework. The server verifies authentication tokens and associates each packet with a call session object stored in memory. The server uses an audio decoding library corresponding to a decoder for the used codec to convert encoded payloads back into linear pulse code modulation samples. The server writes decoded audio frames into a ring buffer for the call session. The input of this step is the stream of encrypted packets from the terminal, and the output of this step is a synchronized stream of reconstructed audio frames suitable for speech recognition.

### Step 5:

The server performs automatic speech recognition on the reconstructed audio frames and outputs raw text information.

The server feeds reconstructed audio frames into a speech recognition engine implemented in a machine learning framework such as TensorFlow or PyTorch. The server computes acoustic features, for example log-mel filter bank features, for each frame and applies a voice activity detector to segment speech and non-speech regions. The server passes sequences of acoustic features through an acoustic model comprising layers such as convolutional layers, transformer encoder layers, and fully connected layers. The server then applies a decoding algorithm, for example beam search combined with a language model, to convert acoustic model outputs into token sequences representing recognized text. The input of this step is the reconstructed audio frame stream from Step 4, and the output of this step is raw text information, comprising partial and full transcripts of utterances in the call.

### Step 6:

The server refines the raw text information by using a generative AI model and outputs corrected text information.

The server constructs a prompt sentence that instructs a generative AI model to correct recognition errors and add punctuation. For example, the server generates a prompt sentence such as:

“The following is a raw automatic speech recognition transcript of a telephone conversation. Please correct recognition errors and add appropriate punctuation, keeping the meaning unchanged: [raw transcript].”

The server inputs the prompt sentence concatenated with the raw transcript into a generative AI model, such as a transformer-based sequence-to-sequence model. The model outputs an improved version of the transcript. The server compares the raw and improved versions, resolves conflicts if necessary, and stores the corrected text information. The input of this step is the raw text information from Step 5 and the prompt sentence generated by the server, and the output of this step is corrected text information with reduced misrecognitions and improved readability.

### Step 7:

The server analyzes the corrected text information with natural language processing and outputs structured information.

The server detects a language of the corrected text and selects appropriate tokenization and morphological analysis tools, for example a morphological analyzer corresponding to MeCab for certain languages. The server segments the corrected text into tokens, assigns parts of speech, and parses syntactic dependencies using a dependency parser such as an implementation similar to a parser provided by spaCy. The server applies a named entity recognition model to identify entities such as persons, organizations, financial institutions, monetary amounts, account identifiers, and time expressions. The server uses sentiment classifiers and topic classifiers, implemented with neural networks, to assign emotional tone and topic labels to sentence segments. The server aggregates all extracted data into structured information, such as a set of key-value pairs and lists describing monetary requests, payment conditions, transaction parties, time references, and participants. The input of this step is the corrected text information from Step 6, and the output of this step is structured information representing semantic content of the conversation in a machine-readable form.

### Step 8:

The server generates or enriches structured information using a generative AI model and outputs enhanced structured information.

The server constructs a prompt sentence to instruct the generative AI model to extract entities and labels from the corrected text. For example, the server generates a prompt sentence such as:

“Analyze the following telephone conversation transcript. Extract key entities (people, banks, account numbers, amounts, deadlines) and label each utterance by topic and emotional tone. Output the result as a structured description in plain text. Transcript: [corrected transcript].” The server inputs the prompt sentence and the corrected transcript into the generative AI model and receives a textual response describing entities, topics, and tones. The server parses the response, aligns it with previously created structured information, and merges any new elements or corrections into an enhanced structured information object. The input of this step is the corrected text information and preliminary structured information from Step 7 together with the prompt sentence, and the output of this step is enhanced structured information that combines rule-based extraction and generative AI-based extraction.

### Step 9:

The server generates summary information from the corrected text information and structured information.

The server first applies a sentence scoring algorithm such as TextRank to a graph of sentences, where edge weights represent similarity based on token overlap or vectorized sentence embeddings. The server selects sentences with highest scores that include financial and identity-related information. The server then constructs a prompt sentence to guide a generative AI model in compressing and reorganizing the selected content. For example, the server creates a prompt sentence such as:

“Summarize the following telephone conversation in 3-5 sentences, focusing on who is asking for money, the reason for the payment, the amount, and the bank account details. Use neutral language and do not omit any financial conditions. Conversation: [selected text].”

The server inputs the prompt sentence and the selected text into the generative AI model and receives a concise summary. The server checks the summary against the structured information for consistency and updates fields if needed. The input of this step is the corrected text information and enhanced structured information from Step 8, and the output of this step is summary information that captures essential elements of the conversation relevant to fraud assessment.

### Step 10:

The server evaluates fraud risk using rule-based processing and a trained determination model and outputs a risk score and a risk category.

The server applies fraud determination rules to the structured information and summary information. For example, the server checks if an urgent request for a large amount is made, if a new bank account is introduced, or if the caller discourages consulting other family members. The server sets flags for each triggered rule and assigns partial scores. The server then constructs a feature vector from numerical and categorical attributes, such as requested amount, number of references to urgent timing, emotional tone, presence of specific keywords, and topic classifications. The server inputs this feature vector into a trained determination model, such as a gradient boosting machine or a neural network classifier, to obtain a probability value representing likelihood of fraud. The server combines rule-based partial scores and the probability value into a final risk score by applying a configurable combination function. The server maps the risk score into a risk category, such as low, medium, or high, based on threshold configurations. The input of this step is the enhanced structured information and summary information from Step 9, and the output of this step is the fraud risk, represented by the risk score and risk category.

### Step 11:

The server generates explanation information regarding the fraud risk using a generative AI model.

The server assembles data describing the decision context, including the summary information, key structured attributes, risk score, risk category, and a list of triggered rules. The server constructs a prompt sentence such as:

“Given the following conversation summary, extracted attributes, triggered rules, and risk score, explain in plain language why this call is likely or unlikely to be a telephone scam. Highlight specific phrases, amounts, and patterns that contributed to the decision. Data: [summary, attributes, rules, score].”

The server inputs this prompt sentence and the associated data into the generative AI model and obtains explanation information that describes reasons behind the risk classification. The server stores this explanation information together with the call record. The input of this step is the decision-related data from Step 10 and the prompt sentence, and the output of this step is explanation information that can be used for transparency and review.

### Step 12:

The server generates warning information and notification information and sends them to the terminal and related-party terminals.

The server composes warning information for the user terminal, including a concise warning message, the risk category, and optionally a short explanation derived from the explanation information. The server also composes notification information for registered related-party terminals, which includes call time information, summary information, the risk category, and recommended action information such as “Please contact the user and advise them not to send money until verification.” The server sends the warning information to the user terminal through an existing session and sends the notification information through communication services such as email or messaging APIs. The input of this step is the risk score, risk category, summary information, and explanation information from Steps 10 and 11, and the output of this step is delivered warning information at the user terminal and delivered notification information at related-party terminals.

### Step 13:

The terminal presents warning information to the user and outputs an audio alert. The terminal receives warning information from the server and parses the included fields. The terminal displays a visual warning on a display, for example, a message such as “This call may be a scam. Please do not transfer money.” The terminal uses a text-to-speech engine provided by the operating system or an external library to synthesize a spoken version of the warning and plays it through a speaker. The input of this step is the warning information from Step 12, and the output of this step is a visual display change and a generated audio signal that alerts the user during the ongoing call.

### Step 14:

The terminal collects user feedback and sends feedback information to the server. The terminal presents user interface controls such as buttons labeled “This is fraud,” “This is safe,” or “Not sure” after the warning or after the call ends. The user selects one of these options based on their judgment. The terminal packages this selection together with a call identifier and time information as feedback information and transmits it to the server. The input of this step is the user's selection provided via the terminal interface, and the output of this step is structured feedback information delivered to the server for model improvement.

### Step 15:

The server updates learning data and may retrain the determination model using feedback information.

The server receives feedback information from the terminal and associates it with stored call records, including feature vectors, structured information, and summary information. The server stores this combined data as labeled learning data, marking each call as fraudulent, non-fraudulent, or uncertain based on the feedback. At scheduled times or when sufficient new feedback has been collected, the server loads the learning data and retrains or fine-tunes the determination model. The server uses a loss function such as binary cross-entropy, applies gradient-based optimization, and validates performance on a separate validation set. The server then deploys updated model parameters to the fraud evaluation module. The input of this step is the feedback information from Step 14 and corresponding historical call data, and the output of this step is an updated determination model with improved parameters that reflects recent user-labeled data.

### Step 16:

The server updates fraud determination conditions using external information and a generative AI model.

The server periodically acquires textual descriptions of new fraud methods from external information sources such as security advisories. The server constructs a prompt sentence such as:

“Convert the following description of a new telephone scam method into detection keywords, typical expressions, and contextual clues in plain text that can be used to define detection rules. Description: [advisory text].”

The server inputs the description and the prompt sentence into the generative AI model and receives a response listing candidate detection keywords, typical wording patterns, and context conditions. The server parses the response and converts it into rule specifications compatible with the internal rule engine. The server adds or updates rules accordingly. The input of this step is external advisory text and the prompt sentence, and the output of this step is an updated set of fraud determination conditions used in subsequent executions of Step 10.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented monitoring and alerting systems that analyze audio or text conversations often rely on fixed keyword lists or shallow rule sets executed by generic processors. Such systems suffer from several technical shortcomings in terms of computer technology itself. First, a processor that merely scans raw or lightly preprocessed text for static keywords cannot robustly distinguish between normal and abnormal conversations in noisy, real-world environments, which leads to high false-positive and false-negative rates and inefficient use of computation and network resources. Second, conventional pipelines typically treat speech recognition, natural language processing, and alert generation as loosely coupled components, without a unified feature representation or feedback loop. As a result, intermediate results such as acoustic context, grammatical structure, emotion, and topic distribution are not effectively leveraged to refine abnormality detection and notification control, which degrades overall system performance and responsiveness.

Furthermore, existing systems generally invoke generative AI models, if at all, in an ad hoc manner, for example by passing raw or unstructured text to a generative model. Such unstructured prompting fails to exploit the model's capabilities in a predictable, machine-controllable way and can produce inconsistent or noisy summaries that are not suitable as machine-learning features. This lack of a structured prompt strategy prevents systematic optimization of conversation summarization and abnormality judgment, resulting in wasted processing cycles and unstable system behavior from the standpoint of computer efficiency. In addition, conventional systems do not maintain a closed-loop learning process wherein the processor records detailed multi-level data (including raw audio, recognized text, structured linguistic features, generative summaries, abnormality classifications, and user response histories) and uses these as training data to continuously update abnormality determination conditions and detection models. Without such a feedback-driven learning architecture, the system cannot adapt its internal models to evolving abnormal patterns, causing degradation over time in detection accuracy and resource utilization.

There is therefore a need for an improved computer-implemented system and processor configuration that: (i) performs multi-stage signal and language processing, including structured feature extraction and controlled generative summarization; (ii) integrates rule-based and machine-learning-based abnormality determination using rich feature vectors; (iii) dynamically controls multi-channel notification based on abnormality state and severity; and (iv) implements a closed-loop learning mechanism that updates abnormality conditions and models based on recorded operational data and user responses. Such an improvement is desired to enhance the technical performance of the processor and the overall system, including accuracy, robustness, scalability, and efficient use of computational and communication resources.

The specific processing by the specific processing unit 290 of the data processing device 12 in Application Example 1 is realized by the following means.

The present invention provides a server comprising a processor configured to convert audio signals acquired via a communication path into digital data and extract audio information, perform noise reduction and reverberation suppression on the audio information to generate processed audio data, execute speech recognition on the processed audio data to generate time-stamped text information, execute natural language analysis on the text information to generate structured text information including important terms, emotion information, and topic information, generate a prompt sentence for a generative AI model based on the structured text information and, by executing the generative AI model with the prompt sentence, generate summary information and abnormality-related information, generate abnormality determination information by comparing at least the summary information and the abnormality-related information with pre-stored abnormality determination conditions and with a determination model learned from past cases, generate and output warning information and tracking information to at least one notification channel according to the abnormality determination information, and store multi-level record information including at least the audio signals, the text information, the structured text information, the summary information, the abnormality determination information, and notification history, and update the abnormality determination conditions and the determination model based on the record information. This enables the server to implement an integrated, multi-stage processing pipeline in which structured linguistic and semantic features are exploited to construct machine-controllable prompts for a generative AI model, to produce stable and informative conversation summaries, to feed rich feature vectors to a learning-based abnormality classifier, to control multi-channel notification behavior according to detected abnormal states and severity, and to perform closed-loop adaptation of detection logic and models based on accumulated operational data, thereby improving the accuracy, robustness, and computational efficiency of abnormal conversation detection and alerting in a computer-implemented monitoring environment.

The term “audio signal” refers to an analog or digital representation of sound, including speech, captured by a transducer such as a microphone and capable of being processed by electronic circuitry or a computing device.

The term “communication path” refers to any wired or wireless communication medium or network, including but not limited to telephone lines, local area networks, wide area networks, and the internet, through which data including audio signals is transmitted between devices.

The term “digital data” refers to information represented in discrete numerical form, such as binary values, that can be stored, processed, or transmitted by a computing device. The term “audio information” refers to data derived from an audio signal, including but not limited to amplitude values, frequency components, temporal structure, and other characteristics usable for further processing such as speech recognition.

The term “noise reduction” refers to processing that suppresses or removes unwanted components of an audio signal, such as background noise, while preserving desired components such as speech.

The term “reverberation suppression” refers to processing that reduces the effects of reflections and echoes in an audio signal to improve clarity of the primary sound source. The term “processed audio data” refers to audio information that has been modified by one or more signal processing operations, including noise reduction and reverberation suppression, to emphasize features of interest such as speech components.

The term “speech recognition” refers to a computational process that converts spoken language contained in audio data into corresponding text information using models such as acoustic models and language models.

The term “acoustic model” refers to a statistical or machine-learned representation that maps audio features to phonetic or subword units for use in speech recognition.

The term “language model” refers to a statistical or machine-learned representation that estimates probabilities of sequences of linguistic units, such as words or tokens, to assist in decoding and disambiguating recognized text.

The term “text information” refers to data representing recognized linguistic content in textual form, including characters, words, or sentences, optionally associated with metadata such as timestamps and confidence scores.

The term “time information” refers to data indicating temporal positions or intervals associated with elements of text information or audio information, such as start and end times of words or phrases.

The term “reliability information” refers to data indicating a confidence or probability value associated with a recognition result, classification result, or other computed output.

The term “natural language analysis” refers to processing that interprets and structures text information using computational linguistic techniques, including but not limited to morphological analysis, syntactic analysis, semantic analysis, emotion analysis, and topic extraction.

The term “morphological analysis” refers to processing that segments text into constituent units such as words or morphemes and determines their part-of-speech or other grammatical attributes.

The term “syntactic analysis” refers to processing that determines grammatical relationships and sentence structure among tokens in text, including dependency relations or phrase structures.

The term “emotion analysis” refers to processing that estimates emotional states or affective qualities, such as fear, anger, urgency, or neutrality, from text information.

The term “topic extraction” refers to processing that identifies one or more main subjects or themes expressed in a body of text.

The term “structured text information” refers to text information represented in a structured format, such as a data record or object, that includes extracted attributes such as important terms, parts of speech, syntactic relations, emotion information, and topic information. The term “important terms” refers to words or phrases identified by the system as being salient for understanding the semantics of a conversation or for detecting abnormality, based on criteria such as frequency, position, or learned importance.

The term “emotion information” refers to data representing the result of emotion analysis, such as labels, scores, or distributions indicating one or more emotional states present in a conversation.

The term “topic information” refers to data representing the result of topic extraction, such as labels, identifiers, or distributions indicating one or more topics associated with a conversation.

The term “generative AI model” refers to a machine-learned model configured to generate text or other data outputs in response to input information, such as large language models or sequence-to-sequence models.

The term “prompt sentence” refers to a text-based input instruction provided to a generative AI model, which may include conversation text, structured features, and control information to guide the model's output format and content.

The term “summary information” refers to text or structured data that concisely represents the essential content of a conversation, including entities, actions, context, and potential risks.

The term “abnormality-related information” refers to data derived from generative or analytical processing that indicates the presence, nature, or likelihood of abnormal, suspicious, or risky behavior within a conversation.

The term “abnormality determination conditions” refers to criteria, rules, thresholds, or patterns stored in a storage device and used to classify conversations into categories such as normal, suspicious, or abnormal.

The term “determination model” refers to a machine-learned model configured to compute an abnormality index or classification result from feature values derived from conversations. The term “past cases” refers to previously observed and recorded events, including associated audio, text, labels, and outcomes, used as training or reference data for the determination model.

The term “abnormality determination information” refers to data representing the result of an abnormality judgment, including at least a classification into states such as normal, suspicious, or abnormal, and optionally an abnormality index or score.

The term “normal state” refers to a classification indicating that a conversation is judged to be non-problematic according to abnormality determination conditions and model output. The term “suspicious state” refers to a classification indicating that a conversation exhibits some characteristics associated with abnormal behavior but does not meet criteria for a definitively abnormal state.

The term “abnormal state” refers to a classification indicating that a conversation is judged to represent a high likelihood of problematic, dangerous, fraudulent, or otherwise abnormal behavior.

The term “warning information” refers to data representing alerts or messages generated by the system to notify a user or other recipient of detected abnormality or suspicion.

The term “tracking information” refers to data used to support follow-up or investigation of an event, including identifiers, timestamps, locations, and links to associated audio, text, and classification results.

The term “notification channel” refers to any medium or mechanism used to deliver warning information or tracking information to a recipient, including visual display, audio output, push notification, email, or other communication services.

The term “display device” refers to any apparatus capable of visually presenting information, such as a monitor, terminal screen, or signage unit.

The term “audio device” refers to any apparatus capable of generating sound output, including speakers, headsets, or public address systems.

The term “portable terminal” refers to a mobile computing device, such as a smartphone or tablet, capable of receiving and displaying notifications.

The term “communication terminal” refers to a computing or communication device, such as a desktop computer, dedicated console, or network appliance, capable of sending or receiving data over a communication path.

The term “communication service” refers to a network-based service for transmitting messages or data, including but not limited to electronic mail services, messaging platforms, and push notification services.

The term “record information” refers to data stored by the system that logs details of processing and events, including raw inputs, intermediate results, outputs, and notification histories.

The term “notification history” refers to a subset of record information that logs instances of warnings or notifications issued by the system, including time, channel, recipients, and content.

The term “learning processing” refers to computational procedures that update parameters, rules, or models based on record information and, in some cases, user response data, to improve future abnormality detection performance.

The term “abnormality index” refers to a quantitative value computed by a determination model or algorithm that represents the degree or probability of abnormality in a conversation. The term “feature values” refers to numerical or categorical data derived from text information, structured text information, summary information, or abnormality-related information, used as input to a machine-learning algorithm.

The term “machine learning algorithm” refers to a computational procedure that trains or applies a model to map feature values to outputs such as classifications, scores, or predictions. The term “state classification” refers to the assignment of a conversation or event to one of multiple predefined categories, such as normal, suspicious, or abnormal, based on abnormality determination information.

The term “user response result” refers to data indicating actions taken by a human operator or recipient in response to a notification, such as confirmation, dismissal, escalation, or resolution.

The term “changes in abnormality patterns” refers to variations over time in the characteristics, expressions, or behaviors associated with abnormal or suspicious events, requiring adaptation of models and conditions.

In one embodiment, a server cooperates with one or more terminals and one or more users to implement the system described in the claims. The server is realized by one or more computing devices including at least one central processing unit (CPU), at least one memory, at least one nonvolatile storage device, and at least one network interface. The server optionally uses one or more accelerators such as graphics processing units (GPUs). The terminals are realized by embedded controllers, mobile devices, or personal computers equipped with microphones, audio interfaces, and network interfaces. The user interacts with the system via display devices, audio devices, and communication terminals.

The server executes a program stored in the nonvolatile storage device and loaded into the memory. The program defines a plurality of software modules, including an audio acquisition module, an audio preprocessing module, a speech recognition module, a natural language analysis module, a generative AI interface module, an abnormality determination module, a notification control module, and a learning module. The server stores intermediate and final data in structured data repositories, such as relational databases and key-value stores. The terminal converts an analog sound signal captured by a microphone into digital audio data. The terminal uses an analog-to-digital converter integrated in a system-on-chip, for example a general-purpose mobile processor with an audio codec. The terminal samples the analog signal at predefined parameters such as 16 kHz sampling rate and 16-bit resolution and produces linear pulse code modulation (PCM) frames. The terminal segments the PCM frames into fixed-length blocks and attaches metadata including terminal identifier, location identifier, and timestamps. The terminal transmits the blocks through a secure communication protocol to the server.

The server receives the digital audio data via a network interface and stores the audio blocks in a memory buffer. The server uses a standardized file or stream format, such as a linear PCM stream or an audio container format, as an internal representation. The server applies an audio preprocessing module to the buffered data. The audio preprocessing module uses digital signal processing operations such as spectral subtraction, Wiener filtering, and echo cancellation. For example, the server computes a short-time Fourier transform (STFT) of each block, estimates a noise spectrum based on non-speech segments, and subtracts the estimated noise from the magnitude spectrum. The server then reconstructs the time-domain signal by applying an inverse STFT. The server normalizes the amplitude so that the speech segments fall within a target dynamic range. These operations reduce background noise and reverberation and thereby improve the quality of features used by the speech recognition module.

The server executes the speech recognition module on the processed audio data. In one embodiment, the server uses a deep neural network acoustic model implemented by a stack of convolutional layers and recurrent layers or transformer layers. The server may use a model of the sequence-to-sequence type with attention or a hybrid model combining a hidden Markov model with a deep neural network. The server extracts acoustic features such as Mel-frequency cepstral coefficients (MFCCs) or log Mel filterbank energies from the processed audio frames. The server inputs the feature vectors into the acoustic model and obtains posterior probabilities for subword units. The server combines these probabilities with a statistical or neural language model using a beam search decoder to generate text sequences. The server outputs text information including words or tokens, time stamps indicating start and end times of each word, and reliability information indicating confidence scores for each recognition result.

The server stores the text information in a structured format. For example, the server stores each conversation as a record containing terminal identifier, time window, recognized text, and per-word metadata. The server then executes the natural language analysis module on the text information. The natural language analysis module performs morphological analysis by tokenizing text and assigning part-of-speech tags. The server may use a morphological analyzer such as a dictionary-based analyzer or a neural sequence labeler. The server then performs syntactic analysis using a dependency parser implemented by a neural network. The server generates a dependency tree that represents grammatical relations between tokens. The server computes emotion information and topic information by applying trained classifiers and topic models. For emotion information, the server uses a neural network classifier, for example a transformer-based model fine-tuned on labeled emotion data. The server inputs token embeddings or sentence embeddings and obtains probabilities for multiple emotion classes such as “fear,” “anger,” “urgency,” and “neutral.” For topic information, the server uses a probabilistic topic model or a neural topic model. The server computes topic distributions for each conversation and assigns topic labels such as “financial transaction,” “physical threat,” or “assistance request.” The server aggregates these outputs into structured text information that includes tokens, part-of-speech tags, dependency relations, emotion scores, topic scores, and lists of important terms extracted using methods such as TF-IDF weighting or attention-based scoring.

The server generates a prompt sentence for a generative AI model based on the structured text information. The generative AI interface module constructs the prompt sentence using a predetermined template. For example, the server may construct a prompt sentence in the following form:

“Summarize the following conversation. Conversation text: [conversation text]. Important terms: [list of terms]. Emotions: [emotion labels and scores]. Topics: [topic labels]. In your summary, clearly describe who is involved, where the event occurs, what happens, and whether there is any risk or abnormal behavior.” The server may also use variant prompt sentences such as:

“The server inputs this conversation text along with extracted key phrases and emotions, and generates a concise summary that clearly explains what happened, who is involved, and whether there is any sign of danger or abnormal behavior.” The server sends the prompt sentence and associated input text to the generative AI model via an application programming interface. The generative AI model is a large language model implemented by a deep neural network including an embedding layer, multiple self-attention layers, and a final projection layer. The server provides the model with the prompt sentence and receives a generated text output. The server interprets part of the output as summary information and part of the output as abnormality-related information, such as explicit mentions of suspicious phrases or inferred risks.

The server executes the abnormality determination module using the summary information, abnormality-related information, and structured text information. The abnormality determination module obtains a rule-based evaluation and a model-based evaluation. For the rule-based evaluation, the server compares tokens, phrases, and patterns in the summary information and text information with abnormality determination conditions stored in a database. These conditions include lists of critical terms, phrase templates, and logical combinations that indicate abnormal behavior. For example, the server may check if the conversation includes terms representing urgent need for money combined with terms indicating change of transfer destination and unknown account information.

For the model-based evaluation, the server converts the structured text information and summary information into numerical feature values. The features include counts of important terms, sentence length, sentiment scores, topic probabilities, and indicators of certain syntactic patterns. The server normalizes and scales the feature values and inputs them into a trained determination model. The determination model is realized by a machine learning algorithm, such as a gradient boosting model, a random forest, or a feedforward neural network. During inference, the server computes an abnormality index representing the probability or degree of abnormality. The server combines the rule-based result and the abnormality index to generate abnormality determination information that classifies each conversation into a normal state, a suspicious state, or an abnormal state.

The server then executes the notification control module according to the abnormality determination information. When the abnormality determination information indicates a suspicious state or an abnormal state, the server generates warning information and tracking information. The server stores the information in an incident record including time, location, summary, abnormality index, and detected patterns. The server selects appropriate notification channels based on state classification and abnormality index. For example, when the abnormal state is severe, the server selects display output on a facility dashboard, voice output via a public address system, push notifications to portable terminals, and messages via communication services. The server composes human-readable messages that include the summary information and basic guidance, such as “Abnormal conversation detected near the main entrance. Please check the situation immediately.”

The terminal receiving a notification displays the message on a screen or outputs an audio alert. The user reads or hears the alert and may confirm, escalate, or resolve the incident via a user interface. The user's response is sent back to the server and stored as a user response result. The server associates the user response result with the corresponding incident record in the record information.

The server executes the learning module using the record information. The learning module periodically or conditionally retrieves conversations, abnormality determination information, and user response results from storage. The server uses these data as training examples for updating the determination model and the abnormality determination conditions. For example, the server uses a supervised learning procedure to minimize a loss function defined on the difference between predicted abnormality indices and target labels derived from user responses. The loss function may be a cross-entropy loss or a mean squared error. The server updates the model's parameters using an optimization method such as stochastic gradient descent or a variant thereof. The server also updates thresholds and rules in the abnormality determination conditions based on updated statistics of features and false outcomes. This architecture improves computer technology in several ways. The server uses multi-stage processing that transforms raw audio signals into progressively more structured representations, thereby reducing ambiguity and noise at each stage. The combination of deep neural acoustic models, structured linguistic analysis, and controlled generative summarization yields summary information and abnormality-related information that are optimized for machine interpretation, not merely for human readability. This leads to improved classification accuracy and lower false positives and false negatives compared with systems that rely only on raw text scanning.

Furthermore, the server uses a specialized prompt sentence construction method to control the generative AI model. By encoding key features such as important terms, emotion information, and topic information into the prompt sentence, the server guides the generative AI model to output summaries that follow a predetermined structure. This structured prompting reduces variability of generative outputs and makes them more suitable as consistent machine-learning features. This is a technical improvement in how generative models are integrated into deterministic pipelines, leading to more stable and efficient downstream computations. The system also achieves improved processing efficiency and reduced communication load. The server can perform noise reduction and feature extraction close to the input stage, allowing shorter and more compact representations to be used in later modules. The classification model can operate on low-dimensional feature vectors instead of raw text, reducing computational cost. The notification control module can avoid sending notifications for normal states and can suppress redundant alerts for persistent events, thereby reducing network traffic and user interface overload.

The server implements non-conventional processing sequences that differ from simple human procedures. For example, a human operator might read transcripts and manually judge abnormality based on intuition. In contrast, the server decomposes each conversation into quantifiable feature values, applies formal rules, and uses machine-learned thresholds and models trained on large-scale historical data. The determination of abnormality is based on a combination of syntactic structures, emotion patterns, topic distributions, and generative summary outputs, which is not feasible for human operators to compute at scale or in real time. This demonstrates that the system is more than a mere automation of existing human activity.

In alternative embodiments, the server may use different neural network architectures for the acoustic model, such as a time-delay neural network or a conformer-based network. The server may use different natural language analysis configurations, such as separate models for entity recognition and relation extraction. The generative AI model may be executed locally on the same hardware as the server or remotely via a dedicated inference service. The terminal may be a fixed surveillance unit in a facility, a mobile device carried by staff, or a desktop computer in a control room. The notification channels may be adapted to different deployment environments, such as industrial plants, transport hubs, or healthcare facilities.

In yet another embodiment, the server uses on-device models on the terminal for preliminary processing. The terminal may perform partial noise reduction and keyword spotting, then transmit only segments likely to contain conversation. This reduces bandwidth usage and server processing load, while the server still performs detailed analysis, generative summarization, and abnormality determination. The same architecture of structured analysis and closed-loop learning applies in this case, and the technical effects of improved accuracy, robustness, and efficiency are maintained.

By configuring the server, the terminal, and the user interaction in this manner, the system provides a concrete implementation that allows a person skilled in the art to realize the claimed invention. The described modules, data structures, model architectures, and update mechanisms collectively improve the functioning of the computer system as a whole and provide technical advantages in speed, accuracy, resource utilization, and adaptability in abnormal conversation detection and alerting.

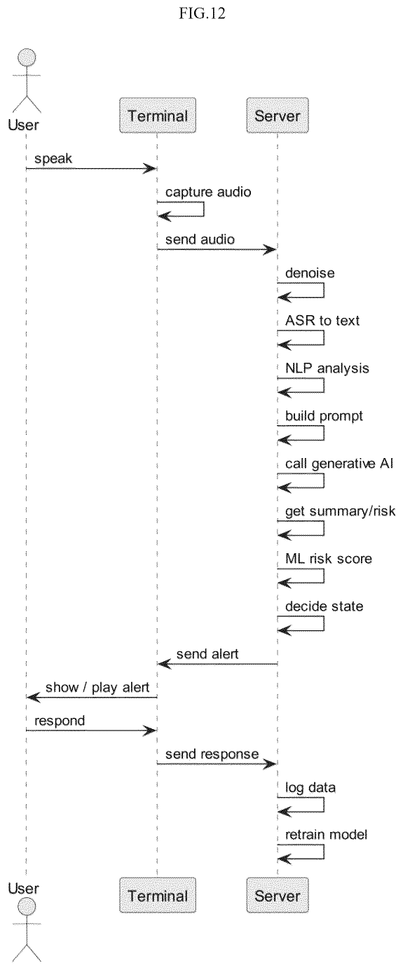

The following describes the processing flow using FIG. 12.

### Step 1:

The terminal acquires an analog audio signal from a microphone installed in a monitored area and converts the analog audio signal into digital audio data. As input, the terminal receives a continuous analog voltage corresponding to ambient sound. The terminal uses an analog-to-digital converter of a system-on-chip to sample the signal at a predefined sampling rate and quantization bit depth, thereby performing numerical conversion of the waveform into linear PCM samples. As output, the terminal produces a sequence of PCM frames with attached metadata such as terminal identifier, location identifier, and timestamps.

### Step 2:

The terminal segments the continuous digital audio data into blocks and transmits the blocks to the server over a communication network. As input, the terminal receives the stream of PCM samples and associated metadata from Step 1. The terminal groups a fixed number of samples into frames, stores them in a buffer, encapsulates them into network packets, and attaches headers containing identifiers and timing information. As output, the terminal sends structured audio packets via a secure protocol, such as an encrypted TCP/IP connection, to the server.

### Step 3:

The server receives the audio packets from the terminal and reconstructs a buffered audio stream for processing. As input, the server receives sequences of packets containing PCM frames and metadata through a network interface. The server validates packet integrity, orders packets by timestamp, and reassembles them into a time-aligned audio buffer in memory. As output, the server stores a continuous or quasi-continuous digital audio stream together with a session record that includes terminal identifiers, location identifiers, and time intervals.

### Step 4:

The server performs noise reduction and reverberation suppression on the buffered audio stream to generate processed audio data emphasizing speech features. As input, the server uses the reconstructed audio buffer from Step 3. The server divides the stream into overlapping time windows, computes a short-time Fourier transform for each window, estimates background noise spectra using non-speech segments, and applies spectral subtraction or Wiener filtering to reduce noise components. The server also applies echo cancellation filters and amplitude normalization. As output, the server generates a sequence of cleaned audio frames with reduced noise and reverberation, which are stored in a processed audio buffer.

### Step 5:

The server executes speech recognition on the processed audio buffer to generate text information with timing and confidence values. As input, the server uses the processed audio frames from Step 4. The server extracts acoustic feature vectors, such as log Mel filterbank energies, and inputs these feature vectors into a deep neural network acoustic model combined with a language model. The server performs decoding using beam search to determine the most likely sequence of tokens, while computing start time, end time, and confidence score for each token. As output, the server produces text information that includes recognized words or subword units, time information for each unit, and reliability information for the recognition.

### Step 6:

The server performs natural language analysis on the text information to generate structured text information. As input, the server uses the tokenized text and associated timing and confidence data from Step 5. The server executes morphological analysis to assign part-of-speech tags, executes syntactic analysis to construct dependency trees, and executes named entity recognition to identify entities such as persons, locations, and monetary amounts. The server then performs emotion analysis using a trained classifier to compute emotion labels and scores, and performs topic extraction using a topic model to compute topic labels and distributions. As output, the server creates structured text information that encapsulates tokens, grammatical relationships, entities, important terms, emotion information, and topic information in a unified data structure.

### Step 7:

The server generates a prompt sentence for a generative AI model based on the structured text information. As input, the server receives the structured text information from Step 6. The server selects the conversation text, the list of important terms, the dominant emotions with scores, and the main topics. The server combines these elements using a predefined template to construct a prompt sentence. For example, the server may generate: “Summarize the following conversation. Conversation text: [conversation text]. Important terms: [terms]. Emotions: [labels and scores]. Topics: [labels]. In your summary, clearly describe who is involved, where the event occurs, what happens, and whether there is any risk or abnormal behavior.” As output, the server produces a formatted prompt sentence and an associated input payload for the generative AI model.

### Step 8:

The server executes the generative AI model with the prompt sentence to obtain summary information and abnormality-related information. As input, the server sends the prompt sentence and the relevant conversation context from Step 7 to a large language model via an application programming interface or an internal inference engine. The server feeds the text as a sequence of tokens, runs the model's forward propagation through embedding layers and multiple self-attention layers, and decodes an output sequence using greedy or beam search. The server then parses the generated text to separate a concise summary of the conversation from explicit descriptions of potential risks or abnormality indicators. As output, the server obtains summary information describing the essential content and abnormality-related information indicating suspected risks or unusual behavior.

### Step 9:

The server generates feature values for abnormality determination using the structured text information, summary information, and abnormality-related information. As input, the server uses the outputs of Steps 6 and 8. The server computes numerical features such as counts of specific important terms, aggregated sentiment scores, topic probabilities, presence of certain syntactic patterns, and flags extracted from the abnormality-related text. The server normalizes these features, encodes categorical values, and constructs a feature vector representing each conversation. As output, the server produces a standardized feature vector that serves as input to a determination model.

### Step 10:

The server calculates an abnormality index and state classification using a determination model and abnormality determination conditions. As input, the server uses the feature vector from Step 9, together with stored abnormality determination conditions. The server inputs the feature vector into a trained machine learning model, such as a gradient boosting classifier or a neural network, to compute an abnormality index representing the likelihood of abnormal behavior. The server compares this index with threshold values defined in the abnormality determination conditions and also checks rule-based patterns such as combinations of critical phrases. As output, the server produces abnormality determination information that includes the abnormality index and a state classification of normal, suspicious, or abnormal.

### Step 11:

The server generates warning information and tracking information according to the abnormality determination information. As input, the server uses the abnormality index, state classification, and summary information from Steps 8 and 10. The server composes human-readable messages describing the event, severity, location, and recommended actions. The server also constructs tracking information including identifiers, timestamps, and links to stored audio and text records. As output, the server creates one or more notification payloads tailored to different channels, such as display messages, audio alerts, push notifications, or messages for communication services.

### Step 12:

The server selects notification channels and transmits the warning information and tracking information to terminals and external services. As input, the server uses the notification payloads and state classification from Step 11. The server applies channel selection rules that map severity levels to specific combinations of display output, audio output, and remote notifications. The server then issues display commands to facility terminals, sends audio alert control messages to audio devices, dispatches push notifications to portable terminals via notification services, and transmits messages to external communication services. As output, the server causes the terminal to render visual alerts, the audio device to output warning sounds or synthesized speech, and remote recipients to receive notifications containing the summary and incident details.

### Step 13:

The user receives the notifications and performs response actions which are recorded by the server. As input, the user receives display messages on a terminal screen, hears audio alerts from an audio device, or views push notifications on a portable terminal. The user inspects the location or situation, and then operates a user interface to acknowledge the alert, classify the event outcome, or provide comments. As output, the user generates response data, such as confirmation, false alarm indication, or escalation status, which is transmitted back to the server and stored in association with the corresponding incident.

### Step 14:

The server stores comprehensive record information and prepares data for learning processing. As input, the server collects the original audio signals, processed audio data, text information, structured text information, summary information, abnormality determination information, notification events, and user response results from previous steps. The server organizes this data in a database using relational tables or document structures, linking each component via unique identifiers and timestamps. The server also derives training labels from user responses, such as “true abnormal” or “false alarm.” As output, the server maintains a coherent dataset that can be used to retrain models and adjust abnormality determination conditions.

### Step 15:

The server updates the determination model and abnormality determination conditions using learning processing. As input, the server uses the record information and training labels from

Step 14. The server splits the data into training and validation sets, computes feature vectors as in Step 9, and trains or fine-tunes a machine learning model by minimizing a defined loss function that measures the discrepancy between predicted abnormality indices and target labels. The server updates model parameters via an optimization algorithm and recalibrates thresholds, rule sets, and pattern definitions in the abnormality determination conditions according to observed performance metrics. As output, the server produces an updated determination model and revised abnormality determination conditions that are stored and used in subsequent executions of Steps 9 and 10.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional telephone fraud detection systems typically rely on keyword spotting or static rule sets that operate only on text transcriptions of call audio. Such systems suffer from multiple technical limitations in terms of computer technology. First, because they do not integrate acoustic emotion cues with linguistic content, they fail to exploit rich multimodal information available in real-time audio streams, leading to low detection accuracy when fraud patterns evolve or when callers avoid obvious trigger words. Second, traditional architectures perform fraud detection in a monolithic manner and do not provide an explicit control interface for generative AI models; as a result, large-scale language models and speech models, if used at all, operate as black boxes without systematic prompt design, making their outputs unstable and difficult to combine with deterministic rule engines and trained classifiers. Third, existing systems do not close the loop between user feedback and model behavior in an engineering-robust way: they often collect feedback in an ad hoc fashion, without structuring it as learning data that can be systematically fed back into the fraud-detection models and emotion-recognition models, which prevents continuous improvement of model parameters and thresholds. Fourth, prior systems do not dynamically tailor warning messages to the user's real-time emotional state; they either push uniform warnings or use simple templates, which can cause overreaction, warning fatigue, or insufficient attention, and therefore do not optimize system-level interaction between detection components and user-facing notification components.

From a computer-technology perspective, there is therefore a need for an improved system architecture and processing pipeline in which a processor: (1) acquires and pre-processes audio, performs noise reduction, and robustly recognizes speech; (2) executes structured natural language processing to generate conversation summaries and subject labels; (3) estimates time-varying emotional states by combining acoustic feature extraction with textual context; (4) computes fraud risk by integrating a rule-based engine, a trained fraud determination model, and a generative AI model controlled through explicit prompt sentences; and (5) automatically generates and delivers context-sensitive warnings and third-party notifications, while collecting user feedback as structured learning data for automated retraining. Such a system should technically improve the way computing resources are orchestrated for multimodal fraud detection, provide a controllable interface to generative AI models, and implement a feedback-driven learning control mechanism that continuously refines fraud-detection and emotion-recognition performance.

The specific processing by the specific processing unit 290 of the data processing device 12 in Example 2 is realized by the following means.

The present invention provides a server comprising a processor configured to acquire audio signals via a communication path, convert the audio signals into digital audio data, perform noise reduction processing on the digital audio data, and convert noise-reduced audio data into text data by using a speech recognition function; analyze the text data by executing morphological analysis and syntactic analysis, generate a conversation summary and a subject label including expressions related to monetary requests or account information requests by using a natural language processing function; extract acoustic feature quantities from the noise-reduced audio data and estimate a time-varying emotional state of a speaker during a call on the basis of the acoustic feature quantities and on the basis of at least one of the text data and the conversation summary by using an emotion recognition function; calculate a fraud risk for each call by performing matching between the conversation summary, the subject label, and the time-varying emotional state, on the one hand, and a fraud determination condition and a trained determination model, on the other hand, input at least one of the text data and the conversation summary together with a prompt sentence into a generative AI model, acquire from the generative AI model a text output indicating an estimation of the fraud risk and a reason for the estimation, and determine a fraud possibility of the call by integrating the fraud risk and the text output by using a fraud determination function; determine, when the fraud risk is determined to be equal to or greater than a threshold by the fraud determination function, presence or absence of a warning, a warning strength, and presence or absence of a notification to a third party on the basis of the fraud risk and the emotional state, input the fraud risk, the emotional state, and a prompt sentence into the generative AI model, cause the generative AI model to automatically generate a warning message that takes into account a psychological state of a user, present the warning message by at least one of a display unit and an audio output unit of a terminal, and transmit a notification to a registered related party as needed by using a warning notification function; and acquire feedback information relating to an actual presence or absence of fraud of the call and relating to an appropriateness of warning content, the feedback information being input by the user after termination of the call, store the feedback information as learning data, and use the feedback information for a relearning process to update parameters of the trained determination model and parameters of the emotion recognition function by using a learning control function. This enables a computer-implemented fraud-prevention system that technically improves multimodal fraud detection accuracy and robustness by combining structured audio pre-processing, linguistic analysis, and emotion recognition; provides a controllable interface to a generative AI model through explicit prompt sentences for both fraud-risk estimation and adaptive warning generation; and realizes a closed feedback loop in which user-supplied labels are systematically exploited to retrain and refine the underlying determination models and thresholds, thereby enhancing overall system performance and reliability over time.

The term “audio signal” refers to an analog or digital signal representing human speech transmitted via a communication path such as a wired line, wireless link, or packet network.

The term “digital audio data” refers to a sequence of numerical values obtained by sampling and quantizing an analog audio signal at a predetermined sampling frequency and bit depth. The term “noise reduction processing” refers to signal processing that suppresses or removes unwanted components such as background noise, line noise, or echo from digital audio data, for example by filtering, spectral subtraction, or echo cancellation.

The term “speech recognition function” refers to processing that analyzes digital audio data and automatically generates text data corresponding to spoken utterances by using an acoustic model, a language model, or a combination thereof.

The term “text data” refers to character-based information representing the linguistic content of speech, produced by a speech recognition function and used as input to natural language processing.

The term “morphological analysis” refers to natural language processing that divides text data into minimal language units such as words or morphemes and assigns linguistic attributes such as part-of-speech tags to each unit.

The term “syntactic analysis” refers to natural language processing that determines grammatical or dependency relationships among words or phrases in text data, including structures such as subject, object, and predicate.

The term “conversation summary” refers to condensed text derived from original text data, in which important information in a call is extracted and represented in a shorter form than the original.

The term “subject label” refers to categorical information indicating a main topic or theme of a call, such as a monetary request or an account information request, expressed as a discrete label.

The term “expression related to a monetary request” refers to a phrase or sentence indicating an intention to request payment, remittance, transfer, or delivery of money from one party to another.

The term “expression related to an account information request” refers to a phrase or sentence indicating an intention to request disclosure, confirmation, or change of financial account information such as account numbers, financial institution names, or account holder names.

The term “acoustic feature quantities” refers to numerical parameters extracted from audio data, including at least one of fundamental frequency, energy, spectral envelope, cepstral coefficients, speaking rate, or zero-crossing rate, which characterize speech properties. The term “time-varying emotional state” refers to a sequence of estimated emotional labels or scores over time during a call, indicating psychological conditions such as calm, anxiety, strong anxiety, confusion, rush, or panic.

The term “emotion recognition function” refers to processing that estimates an emotional state of a speaker on the basis of acoustic feature quantities and optionally textual information by using a statistical model or machine learning model.

The term “fraud determination condition” refers to a set of rules or criteria used to judge a probability that a call is fraudulent, including patterns of keywords, topics, contexts, and emotional changes.

The term “trained determination model” refers to a machine learning model that has been trained on historical fraud and non-fraud data to output a fraud risk score or label from input features.

The term “fraud risk” refers to a numerical value or level indicating a likelihood that a call is fraudulent, expressed, for example, as a continuous score or as a category such as low, medium, or high.

The term “fraud possibility” refers to an overall determination result that indicates whether a call is likely to be fraudulent, based on integration of rule-based scores, model outputs, and auxiliary analyses.

The term “fraud determination function” refers to processing that calculates a fraud risk and determines a fraud possibility of a call by using at least one of a fraud determination condition, a trained determination model, and output from a generative AI model. The term “generative AI model” refers to a machine-implemented model, typically based on deep learning, that generates new content such as text or speech in response to input data and instructions, and that is capable of performing natural language understanding and generation. The term “prompt sentence” refers to a textual instruction or description provided as input to a generative AI model to specify what processing the model should perform and what form of output it should generate.

The term “warning message” refers to text generated to inform a user that a call may be fraudulent and to recommend caution or specific countermeasures, and which can be presented by a display device or a speech output device.

The term “warning notification function” refers to processing that determines whether and how to present a warning message to a user and whether to send notifications to third parties, and that controls display output, audio output, and external communications accordingly. The term “registered related party” refers to an entity other than the user, such as a family member, acquaintance, monitoring service, or security organization, whose contact information has been stored in advance for the purpose of receiving notifications. The term “learning data” refers to data used for training or retraining a machine learning model, including at least feedback information, call summaries, emotion information, and fraud determination results.

The term “learning control function” refers to processing that manages collection, storage, and use of learning data, and that performs or triggers retraining to update parameters of a trained determination model or an emotion recognition function.

The term “feedback information” refers to data input by a user after a call, indicating at least whether the call was actually fraudulent and whether a warning was appropriate, and optionally including comments.

The term “terminal” refers to an information processing apparatus connected to a communication line, including at least a display unit or an audio output unit, and configured to acquire call audio and present warning messages under control of a server.

The term “external processing apparatus” refers to a computing resource separate from a terminal, including at least one processor and memory, and configured to execute functions such as speech recognition, natural language processing, emotion recognition, and fraud determination.

The term “electronic communication network” refers to an infrastructure for transmitting digital information, including at least one of the Internet, a mobile communication network, a local area network, or a public switched network.

In one embodiment, a telephone fraud prevention system includes a server, a terminal, and a user. The server is implemented as an information processing apparatus comprising at least one processor, a memory, a non-volatile storage device, and a network interface, operating under a server operating system such as a UNIX-type or Linux-type operating system. The terminal is implemented as an information processing apparatus installed near a call device such as a fixed telephone, and includes a microphone, an analog-to-digital converter, a display unit, a loudspeaker, and a communication module, operating under an embedded operating system or a mobile operating system. The user uses an ordinary call device connected to the terminal, and receives warning messages through the display unit or loudspeaker of the terminal.

The terminal uses a high-sensitivity microphone, such as an electret condenser microphone or a micro-electro-mechanical systems microphone, to capture an analog audio signal corresponding to human speech during a call. The terminal supplies the analog audio signal to the analog-to-digital converter, which samples and quantizes the signal at, for example, a 16 kHz sampling frequency and a 16-bit quantization depth. The terminal stores the resulting pulse-code modulation audio samples into buffers in a main memory under the control of an audio acquisition module. The terminal then applies digital signal processing using a signal processing library, such as a numerical computation library or a dedicated digital signal processing library, to perform noise reduction. The terminal executes, for example, finite impulse response filtering, a short-time Fourier transform, spectral subtraction for stationary noise suppression, and acoustic echo cancellation based on reference far-end audio. By performing these specific operations, the terminal reduces background noise and line noise before transmission, thereby reducing the data variance that the server-side speech recognition function must handle and improving recognition accuracy while also reducing retransmission and error correction overhead in the communication path.

The terminal groups a sequence of cleaned audio samples into blocks, for example, several seconds each, associates each block with a session identifier, timestamp, and user identifier, and transmits the blocks to the server through the communication module. The terminal uses a network protocol stack implementing Transport Layer Security over a hypertext transfer protocol to encrypt and encapsulate the audio data into data packets. The terminal thereby offloads computationally intensive recognition and analysis operations to the server while maintaining a small computational footprint and power consumption locally.

The server receives the encrypted packets via the network interface, decrypts the packets, reconstructs the cleaned audio blocks, and stores the audio blocks in a file system or an object store, while also recording metadata in a structured database. The server uses a task queue, such as a message queue managed by a queue manager process, to schedule successive processing modules such as speech recognition, natural language processing, emotion recognition, fraud scoring, and notification control. By organizing the data and tasks in this structured manner, the server improves data locality and throughput and reduces blocking between modules, which contributes to higher processing speed and scalability compared with monolithic blocking architectures.

The server performs speech recognition using either an internal automatic speech recognition engine or an external service backed by a generative AI model. In one configuration, the server converts the cleaned audio blocks into a standardized audio file format, such as a waveform audio file with 16-kHz, 16-bit, single-channel data, and transmits the file together with a prompt sentence to an external recognition service. The generative AI model is, for example, a deep neural network comprising a stack of convolutional layers for feature extraction from spectrograms, followed by recurrent layers such as long short-term memory units, or transformer layers with self-attention, and a connectionist temporal classification output layer that maps acoustic features to character or subword sequences.

The server constructs a prompt sentence that explicitly constrains the behavior of the generative AI model, for example:

“Convert this audio data into text. Remove background noise as much as possible and transcribe the speaker's utterances accurately, preserving numbers and account information.” By providing such a prompt sentence, the server causes the generative AI model to prioritize numeric sequence preservation and to disregard residual noise tokens, which improves transcription accuracy for financial amounts and account numbers compared with default model usage that does not incorporate such domain-specific constraints. The server receives a transcription result, optionally including time alignment information and confidence scores, and stores the transcription as text data in the database.

The server applies a natural language processing module to the text data. In one embodiment, the server uses a morphological analysis library such as a tokenization and part-of-speech tagging engine to segment the text into morphemes and to assign grammatical categories to each morpheme. The server then uses a syntactic parser, such as a dependency parser implemented with a graph-based or transition-based algorithm, to identify dependency relations among the morphemes, including subject, object, predicate, and modifier relationships. The server further performs named-entity recognition to identify entities corresponding to monetary amounts, financial institutions, account identifiers, and personal identifiers.

The server generates a conversation summary and a subject label by using both deterministic algorithms and a generative AI model. The server uses rule-based extraction to identify sentences containing key patterns such as “transfer [amount] to [account],” “urgent issue with your account,” or “change of registered account,” and then provides the entire text data, the extracted candidate key phrases, and a prompt sentence to the generative AI model. An example of a prompt sentence is:

“Analyze the following call transcript, extract important keywords such as bank transfer, account number, and urgent money request, summarize the entire conversation in 3 to 5 sentences, and output one subject label such as money transfer request, account change request, or personal information request. Transcript: [transcript text].” The generative AI model, which is implemented as a large-scale language model based on transformer encoder-decoder layers trained on large corpora, processes the prompt sentence and the transcript text to perform attention-based aggregation of context and to output a condensed summary and a discrete label indicating the main topic. The server uses these outputs as structured data, thereby converting unstructured call content into structured representations that downstream modules can process more efficiently.

The server derives acoustic feature quantities from the stored audio data. The server uses an audio processing library to compute, for each short time frame, features such as fundamental frequency via pitch detection (for example, using autocorrelation or cepstrum methods), log-scaled energy, Mel-frequency cepstral coefficients using a filter bank and discrete cosine transform, zero-crossing rate, and estimates of speaking rate based on voiced segment detection and syllable count estimation. The server organizes these features into a feature matrix with a fixed dimension per frame and a time axis index. For example, each frame may be represented as a vector of 40 coefficients comprising energy, pitch, and 38 cepstral components, and frames may be spaced every 10 milliseconds. This representation allows the emotion recognition model to capture fine-grained temporal dynamics in prosody and articulation.

The server implements an emotion recognition function as a deep neural network model, such as a bidirectional long short-term memory network or a transformer-based sequence model, that receives the feature matrix and optionally receives an embedding of the conversation summary produced by a text encoder, such as a transformer encoder or a bidirectional recurrent network applied to word embeddings. The network outputs, for each time step or for each segment, a probability distribution over emotion categories such as calm, anxious, highly anxious, confused, rushed, and panic. The model is trained by supervised learning using training data in which human annotators label segments with emotional categories. During training, the server uses a cross-entropy loss function between predicted probabilities and one-hot label vectors, and updates the network weights by a stochastic gradient descent algorithm or a variant such as Adam, with backpropagation through time for sequence processing. The server may perform data augmentation, such as time-stretching, pitch shifting, and additive noise, to increase robustness to variations in recording conditions and speaker characteristics.

The server aggregates the model outputs to produce a time-varying emotional state timeline. For example, the server segments the call into 10-second windows and assigns to each window the emotion category with the maximum average probability. The server then computes derived features, such as the time at which the emotion transitions from calm to highly anxious, the maximum anxiety score, the rate of increase in anxiety after a monetary request utterance, and the number of oscillations between calm and anxious states. These derived features provide informative indicators that are difficult for human operators to compute consistently in real time and that are leveraged by the fraud determination function. The server calculates a fraud risk by integrating rule-based logic, a trained determination model, and an auxiliary generative AI model. In one implementation, the server uses a rule-based engine that maintains a set of conditions such as:
if the subject label equals money transfer request and the amount exceeds a threshold and the call contains urgency expressions, then add a specified weight to a base risk score;
if a sharp increase in anxiety is detected within a defined time window following a monetary request utterance, then add a further weight;
if account information, such as a new account, is requested without prior verification phrases, then add an additional weight.

These rules implement non-conventional combinations of linguistic and emotional signals that are not typically used in manual screening, and they exploit precise timing relations that are easily lost in human perception but are preserved in the server's structured feature representation. The server also constructs a feature vector comprising, for example, one-hot encodings of subject labels, normalized monetary amounts, counts of specific keyword categories, statistical descriptors of the emotional timeline such as mean, variance, maximum, and first-order difference of anxiety scores, and binary indicators of rule matches. The server inputs this feature vector into a trained determination model, such as a gradient boosting machine, a fully connected neural network, or a transformer encoder network trained on labeled fraud and non-fraud calls.

The server trains the determination model by minimizing a loss function such as binary cross-entropy between model outputs and ground truth labels, using a backpropagation algorithm and mini-batch optimization. The server may use regularization techniques such as dropout or L2 weight decay to prevent overfitting and may perform hyperparameter tuning using validation data. By combining rule-based scores and learned model outputs, the server obtains a fraud risk score that is more accurate and more robust to new fraud patterns than a purely rule-based system.

The server further uses a generative AI model to obtain an explanatory text and an auxiliary fraud probability. The server supplies the conversation summary, subject label, and a textual description of the emotional timeline to the generative AI model, together with a prompt sentence, for example:

“Using the following call summary and emotional-state information, estimate the probability from 0 to 1 that this call is a fraud, and explain the main reasons in up to three bullet points. Call summary: [summary text]. Subject label: [subject label]. Emotion overview: [brief description of emotion changes].”

The generative AI model outputs a numeric estimate and a short, structured explanation, which the server combines with the rule-based score and the trained determination model output, for example by computing a weighted average or selecting the maximum among sources depending on confidence thresholds. This multi-source integration improves system resilience to anomalies in any single component and provides an interpretable basis for later audit.

The server implements a warning notification function that controls user interface behavior on the terminal and messaging behavior to third parties. The server maps the final fraud risk score into discrete levels such as low, medium, and high, and consults policy settings that specify, for each level and for each global emotional state (for example, calm vs. highly anxious), whether to present a warning, what intensity to use, whether to include audio output, and whether to notify third parties such as family members or monitoring services. The server prepares parameters describing a desired message tone, length, and style.

The server uses the generative AI model to generate a warning message tailored to the fraud risk and emotional state. The server provides input values such as the fraud risk level, the emotional label, the desired language, and the desired style, and transmits a prompt sentence, for example:

“The user is currently in a ‘highly anxious’ state, and this call is classified as fraud risk level ‘high.’ Create a Japanese warning message in plain style (da/dearu) with at most two sentences that calms the user and urges them to immediately stop any money transfer, hang up the phone once, and consult their family.”

The generative AI model generates one or more sentences, such as: “This telephone call is highly likely to be fraudulent. The user should immediately suspend the transfer, hang up the call once, and consult with family members.”

The server embeds this text into a control message that it transmits to the terminal. The server also constructs notification messages for registered related parties when policies require third-party notification. These notification messages may include the conversation summary, the fraud risk level, the estimated emotional state, and recommended actions, and are delivered via an electronic communication network using protocols such as electronic mail or messaging service APIs.

The terminal receives the control message from the server, decodes the message, and displays the warning text on the display unit using a graphical user interface library appropriate to the operating system. The terminal may employ specific visual designs such as color coding (for example, red for high risk) and pop-up windows that overlay the screen. The terminal also submits the warning text to a text-to-speech engine, for example a speech synthesis library operating locally, which generates synthetic speech audio that is output through the loudspeaker. This coordinated visual and auditory presentation ensures that the warning reaches the user even when the user is focused on the telephone handset and not looking at the terminal. Because warning generation is based on real-time fraud risk assessment and emotional state estimation, the warning content and intensity are technically optimized for current call conditions rather than being a static template.

After the call ends, the server maintains session state and awaits user feedback. The terminal presents an evaluation screen to the user, for example listing items such as “Was this call actually fraud?” and “Was the warning appropriate?” The terminal sends the user's selections and any free-text comment to the server as feedback information. The server stores the feedback in a structured learning database, associating it with the corresponding call features, including conversation summary, subject label, emotional timeline, and previously computed fraud risk. Periodically or when sufficient new feedback has been collected, the server initiates a retraining process. The server extracts feature-label pairs, where labels indicate fraud or non-fraud and may also capture warning appropriateness. The server trains updated versions of the determination model and, optionally, the emotion recognition model, using the same or refined network architectures and learning procedures. The server may also adjust rule thresholds and weights based on statistical analyses of misclassifications. This closed-loop learning control function improves the underlying model performance and reduces false positives and false negatives over time, thereby achieving a technical improvement in classification accuracy and system adaptability.

In contrast to manual operator screening, which relies on human listening and ad hoc judgment, the described system employs precise, machine-implementable rules combined with learned feature representations and deep neural architectures. The system processes high-dimensional acoustic and linguistic feature spaces and uses explicit timing relations that are not feasibly tracked by human operators. The integration of pre-processing, feature extraction, and multi-model fusion leads to reductions in processing time per call, enabling near real-time operation even under high call volumes, and improves computational efficiency by assigning heavy computation to the server while keeping the terminal lightweight. Furthermore, the explicit use of prompt sentences to control generative AI models ensures that such models are not generic black boxes but are configured for specific recognition and generation tasks in a reproducible and machine-controllable manner, thereby improving determinism and safety of outputs.

The server, by structuring audio, linguistic, and emotion features into explicit data structures and by implementing defined processing modules and training methods, produces technical effects including improved speech recognition accuracy under noisy conditions, improved fraud detection precision and recall through multimodal fusion, improved data management through structured storage of derived features and feedback labels, and improved system performance through scalable, asynchronous task scheduling. These effects derive from specific architectural and algorithmic choices rather than mere automation of human cognitive steps, and they demonstrate a concrete improvement in computer technology applied to the domain of telephone fraud prevention.

In alternative embodiments, the server may incorporate different neural network architectures, such as convolutional recurrent hybrid networks for emotion recognition or transformer encoders for fraud classification, and may use alternative loss functions such as focal loss to address class imbalance. The terminal may be integrated into a call device rather than implemented as an external unit, and may support additional sensors such as cameras for further multimodal analysis. The generative AI model may be hosted on the server or on a separate computing platform, and the system may dynamically adjust prompt sentences based on context, such as historical risk patterns for a particular user. In all such variations, the server, the terminal, and the user interact according to the general principles outlined above, and the processor executes the described technical processing to realize the claimed functionality.

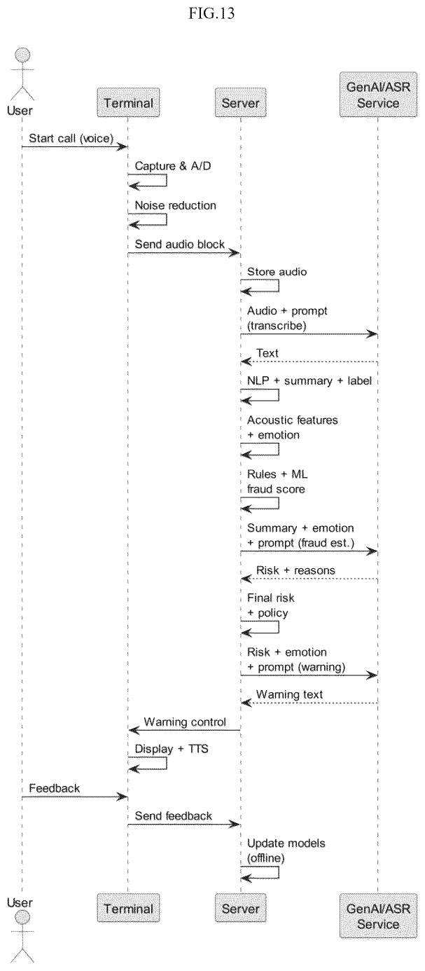

The following describes the processing flow using FIG. 13.

### Step 1:

The terminal uses a microphone as an input device to acquire an analog audio signal corresponding to a telephone conversation. The terminal supplies the analog audio signal as an input to an analog-to-digital converter and performs sampling and quantization at a predetermined sampling frequency and bit depth to generate digital audio data as an output. The terminal stores the digital audio data into a buffer in main memory and appends metadata such as a session identifier and timestamps. The terminal thereby converts continuous analog speech into time-discrete pulse-code modulation samples suitable for subsequent digital signal processing.

### Step 2:

The terminal uses the buffered digital audio data as input to a noise reduction module. The terminal applies filtering in the time domain and frequency domain, including band-pass filtering, short-time Fourier transform, spectral subtraction, and acoustic echo cancellation, to perform data processing that suppresses background noise components and line noise. The terminal outputs noise-reduced digital audio data, in which the speech components are emphasized and the noise variance is reduced. The terminal further segments the noise-reduced audio data into fixed-length blocks, for example several seconds each, and associates each block with the session identifier and timing metadata.

### Step 3:

The terminal uses each block of noise-reduced digital audio data together with metadata as input to a communication module. The terminal encapsulates the audio block into a data structure, performs data processing to serialize and, if necessary, compress the data, and then uses a network protocol stack to encrypt the serialized data using a secure transport protocol. The terminal outputs one or more encrypted data packets and transmits these packets to the server via a communication network. The terminal thereby offloads the high-level recognition and analysis tasks to the server while maintaining minimal local computational load.

### Step 4:

The server uses the encrypted data packets from the terminal as input to a network reception module. The server performs decryption and integrity checking as data processing on the packets, reassembles the packet payloads into the original noise-reduced audio blocks, and extracts associated metadata such as the session identifier and timestamps. The server outputs reconstructed audio blocks and metadata, stores the audio blocks in a storage device, and registers processing jobs in a task queue for later speech recognition and analysis. The server thus converts network traffic into structured audio data objects for further processing.

### Step 5:

The server uses a noise-reduced audio block as input to a speech recognition module. The server calls either an internal automatic speech recognition engine or an external recognition service backed by a generative AI model, and in the latter case prepares a prompt sentence as an additional input. The server executes data processing that converts the audio block into a standardized waveform file, sends the waveform file and the prompt sentence, such as “Convert this audio data into text. Remove background noise as much as possible and transcribe the speaker's utterances accurately, preserving numbers and account information,” to the generative AI model, and receives as output a text transcription and optionally confidence scores. The server stores the transcription as text data associated with the session identifier and thereby converts acoustic data into a machine-readable linguistic representation.

### Step 6:

The server uses the text data as input to a natural language processing module. The server applies morphological analysis to segment the text into tokens and assign part-of-speech tags, and then applies syntactic analysis to compute dependency relations among tokens, performing data processing that identifies grammatical roles such as subject, object, and predicate. The server outputs a parsed text structure, including token sequences and dependency trees. The server further uses the parsed structure as input to a semantic extraction procedure that identifies key phrases related to monetary requests and account information requests, and outputs an intermediate representation containing the original text, the tokenization, the syntactic relations, and tagged key phrases.

### Step 7:

The server uses the text data and the intermediate representation from Step 6 as input to a summarization and topic labeling module. The server constructs an input string comprising the transcript and extracted key phrases, and supplies this input string together with a prompt sentence to a generative AI model as input. The prompt sentence may be, for example, “Analyze the following call transcript, extract important keywords such as bank transfer, account number, and urgent money request, summarize the entire conversation in 3 to 5 sentences, and output one subject label such as money transfer request, account change request, or personal information request. Transcript: [transcript text].” The server executes data processing in which the generative AI model applies attention-based sequence processing to the input and outputs a conversation summary and a subject label. The server stores these as structured data and thus converts verbose call content into compact semantic descriptors.

### Step 8:

The server uses the noise-reduced audio blocks as input to an acoustic feature extraction module. The server divides each block into overlapping short-time frames and performs data computations on each frame, including fast Fourier transforms, filter-bank analysis, and pitch detection. The server calculates acoustic feature quantities such as fundamental frequency, short-time energy, Mel-frequency cepstral coefficients, zero-crossing rate, and speaking rate estimates. The server outputs a time-indexed feature matrix representing the acoustic characteristics of the call and associates this matrix with the session identifier. This feature matrix serves as a numerical representation of prosodic and spectral properties for subsequent emotion analysis.

### Step 9:

The server uses the acoustic feature matrix and at least one of the text data and the conversation summary as input to an emotion recognition module. The server applies a deep neural network, such as a recurrent neural network or transformer network, to perform data computations that map sequences of feature vectors to probability distributions over emotion categories for each time step or segment. The server aggregates the probabilities over fixed time intervals to derive a time-varying emotional state timeline, and outputs this timeline together with global statistics such as maximum anxiety level and rate of change. Optionally, the server supplies the conversation summary and a textual description of the acoustic changes to a generative AI model together with a prompt sentence, such as “Based on the following call summary and acoustic feature overview, estimate the victim-side user's current emotional state and choose one label from calm, anxious, highly anxious, panic, confused, and angry, and explain the reason in one sentence,” and receives an emotion label and explanation as additional output. The server thereby converts multimodal inputs into structured emotional information.

### Step 10:

The server uses the conversation summary, the subject label, the emotional state timeline, and derived emotional statistics as input to a fraud determination module. The server first applies rule-based logic to these inputs, performing data processing that evaluates predefined fraud determination conditions, such as the presence of urgency combined with a money transfer request and a rapid increase in anxiety following the request. The server computes a rule-based fraud score as an output. The server also constructs a feature vector including encoded subject labels, counts of key phrases, monetary amounts, and emotional features, and inputs this vector to a trained determination model, such as a gradient boosting machine or neural network, which performs numerical calculations to output a fraud risk probability. Additionally, the server supplies the conversation summary, subject label, and an overview of emotional changes to a generative AI model together with a prompt sentence, for example, “Using the following call summary and emotional-state information, estimate the probability from 0 to 1 that this call is a fraud, and explain the main reasons in up to three bullet points. Call summary: [summary text]. Subject label: [subject label]. Emotion overview: [brief description],” and receives a text output containing an estimated probability and reasons. The server then integrates the rule-based score, the trained model probability, and the generative AI estimate to output a final fraud risk value and a fraud possibility classification for the call.

### Step 11:

The server uses the final fraud risk value, the fraud possibility classification, and the global emotional label as input to a warning and notification control module. The server performs data processing that compares the fraud risk and emotional state against policy thresholds and user preferences to determine whether to issue a warning, what warning strength to use, whether to enable audio output, and whether to notify a third party. The server outputs control parameters specifying a fraud risk level, a target emotional tone for messaging, a desired language and style, and a list of third-party recipients if applicable. These control parameters serve as inputs for warning message generation and external notification generation.

### Step 12:

The server uses the control parameters from Step 11 as input to a warning message generation module. The server constructs a text prompt that includes the fraud risk level, the emotional state, and desired constraints, such as, “The user is currently in a ‘highly anxious’ state, and this call is classified as fraud risk level ‘high.’ Create a Japanese warning message in plain style (da/dearu) with at most two sentences that calms the user and urges them to immediately stop any money transfer, hang up the phone once, and consult their family.” The server transmits this prompt sentence to a generative AI model as input and receives as output a warning message text tailored to the specified conditions. The server then formats the warning message text into a control message for the terminal, and, if third-party notification is required, uses the conversation summary, fraud risk level, and emotional information as input to compose notification texts for registered related parties. The server outputs both the terminal control message and the third-party notification messages for transmission.

### Step 13:

The terminal uses the control message from the server as input to a user interface control module. The terminal parses the message, extracting the warning text and indications for display and audio output. The terminal performs data processing to render the warning text on the display unit, for example creating a popup window with appropriate color coding and font size, and simultaneously uses the warning text as input to a text-to-speech engine. The terminal executes audio synthesis to convert the text into a speech waveform and outputs the waveform through the loudspeaker. The terminal thus presents the warning message in visual and auditory forms as output. If the server has transmitted third-party notifications directly, the terminal may also indicate on its display that a notification has been sent.

### Step 14:

The user uses the display unit and loudspeaker of the terminal as input channels to receive the warning message output in Step 13. The user interprets the warning and, based on its content, performs actions such as stopping a planned money transfer, terminating the call, or contacting a family member. After the call is completed, the user uses the terminal's input interface, such as touch buttons or keys, to supply feedback information as input, indicating whether the call was actually fraudulent and whether the warning was appropriate. The terminal performs data processing to package this feedback together with the session identifier and sends the feedback to the server, which stores it as labeled learning data. This feedback output from the user serves as input to retraining and adjustment processes executed by the server outside the real-time call handling flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional conversation monitoring and fraud-detection systems primarily rely on keyword spotting and simple rule-based text analysis executed by a computer. Such systems typically convert audio to text using a fixed speech recognizer, scan the text for pre-registered phrases, and trigger alerts whenever certain words appear. This architecture suffers from several technical limitations.

First, conventional systems do not effectively integrate heterogeneous signal streams inside the computer, such as high-dimensional acoustic features, time-varying emotion indicators, and structured natural language representations. As a result, the computer's decision logic tends to treat all keyword occurrences similarly, regardless of the speaker's emotional state or temporal changes in that state, leading to high false positive rates (e.g., jokes or metaphors being misclassified as threats) and false negatives (e.g., fearful or coerced speech without explicit danger words being missed).

Second, conventional systems use independent components for speech recognition, natural language processing, emotion estimation, and anomaly detection that are statically configured and insensitive to context. The internal data flow in such systems is mostly one-directional and hard-wired. The computer cannot flexibly adjust its processing strategies based on current conversation content, emotion dynamics, and overall risk context. For example, the system cannot adaptively refine summaries, re-evaluate risk when emotions spike, or change notification behavior in real time.

Third, when generative AI models are used, they are typically invoked in an ad-hoc manner, for example just to summarize text or answer questions, without being systematically integrated into the core signal processing pipeline of the computer. The lack of a structured “prompt control” mechanism means that the generative AI model's outputs are not consistently aligned with the needs of the speech recognition, natural language processing, emotion recognition, and anomaly detection stages. Consequently, the overall system cannot exploit the generative AI model's capabilities to improve internal representations and decision quality in a stable and reproducible way.

Fourth, conventional alerting mechanisms in such systems are generally static and shallow. They do not compute notification levels based on combined emotion scores and risk estimates, nor do they generate recipient-specific messages that are computationally tailored to different roles (for example, security operators versus family members). The computer therefore cannot systematically optimize the form and routing of alerts based on a multi-factor assessment of risk, emotion, and context, which leads to notification overload, delayed response to critical events, and suboptimal use of monitoring resources.

Accordingly, there is a need for an improved computer-implemented monitoring system that: (i) integrates audio, linguistic, and emotional information in a unified processing pipeline; (ii) computes emotion scores and emotion abnormality values over time and incorporates them directly into anomaly determination; (iii) uses a generative AI model under explicit control by structured prompt sentences as part of the core processing loop, not merely as an auxiliary tool; and (iv) dynamically determines notification levels and recipient-specific warning messages based on combined risk and emotion indicators. Such a system would improve the computer's technical ability to recognize abnormal situations, reduce false positives and false negatives, and generate more relevant and actionable alerts.

The specific processing by the specific processing unit 290 of the data processing device 12 in Application Example 2 is realized by the following means.

The present invention provides a server comprising a processor configured to receive an audio signal via a communication interface, convert the audio signal into digital audio data, and execute, under program control, acoustic signal processing including noise reduction processing and speech recognition processing to convert the audio data into character data; to execute natural language processing on the character data by performing morphological analysis and syntactic analysis so as to extract important words related to danger and monetary requests and to generate summary data representing a summary of a conversation; to extract acoustic feature quantities from the audio data, to perform emotion analysis processing on at least the character data and the summary data, and to calculate, based on the acoustic feature quantities and a result of the emotion analysis processing, an emotion score indicating an emotional state of a speaker and an emotion abnormality degree indicating a temporal change of the emotional state; to compare the summary data and the important words with abnormality determination conditions stored in a storage device, the abnormality determination conditions being conditions for determining occurrence risks of abnormal events including fraud, violence, and theft, and to evaluate the emotion score and the emotion abnormality degree by incorporating the emotion score and the emotion abnormality degree into the abnormality determination conditions so as to determine presence or absence of an abnormality or a risk level in the conversation; to determine, when it is determined that an abnormality has occurred or that the risk level is equal to or greater than a predetermined value, a notification level and a notification destination in accordance with the emotion score and the risk level, and to generate a warning message based on content of the conversation and the emotional state and transmit the warning message to the notification destination via a communication network; and to input instruction information including at least one prompt sentence to a generative AI model, the at least one prompt sentence including a prompt sentence for causing the generative AI model to convert the audio data into the character data, a prompt sentence for causing the generative AI model to generate the summary data from the character data, a prompt sentence for causing the generative AI model to evaluate the risk level based on the content of the conversation and the emotional state, and a prompt sentence for causing the generative AI model to generate the warning message, and to obtain a response result from the generative AI model and use the response result in at least part of the acoustic signal processing and speech recognition processing, the natural language processing, the emotion analysis processing, and the generation and transmission of the warning message. This enables the computer system to internally integrate multi-modal features, to compute and exploit time-varying emotion indicators within the anomaly detection logic, to systematically leverage a generative AI model under explicit prompt control as a component of the core processing pipeline, and to dynamically produce context-sensitive, recipient-specific warning messages based on combined risk and emotion information, thereby technically improving accuracy and robustness of abnormality detection and notification behavior in a facility monitoring environment.

The term “audio signal” refers to an analog signal representing sound, including speech and environmental noise, that is received from an audio acquisition device and provided to the system for processing.

The term “audio data” refers to digital data obtained by sampling and quantizing the audio signal, for example as pulse code modulated samples, and used as input for acoustic signal processing and speech recognition processing.

The term “character data” refers to digital text data representing recognized speech content obtained by applying speech recognition processing or text generation processing to the audio data.

The term “acoustic signal processing” refers to processing applied to the audio data to modify or enhance the sound, including at least noise reduction processing, echo cancellation processing, and other filtering operations that improve intelligibility of a speaker's voice. The term “noise reduction processing” refers to processing that estimates and attenuates background noise components in the audio data so as to improve the clarity of foreground speech.

The term “speech recognition processing” refers to processing that applies an acoustic model and a language model to the audio data in order to convert spoken utterances into character data representing words, phrases, or sentences of a natural language.

The term “morphological analysis” refers to processing that segments the character data into word or morpheme units and assigns part-of-speech or other linguistic attributes to each unit. The term “syntactic analysis” refers to processing that determines syntactic structures and dependency relationships among words or morphemes in the character data, including at least subject, predicate, and object relationships.

The term “important words” refers to a subset of words or expressions included in the character data that are determined, based on linguistic analysis and statistical or graph-based methods, to have a high relevance to abnormal events such as danger, violence, monetary requests, fraud, or theft.

The term “summary data” refers to text data representing a condensed form of content of the character data, the summary data being generated by extracting and expressing main points of a conversation in a shorter textual form.

The term “acoustic feature quantities” refers to numerical feature vectors extracted from the audio data, including at least measures such as energy, spectral characteristics, fundamental frequency, speaking rate, and silence duration, which are indicative of the acoustic properties of speech.

The term “emotion analysis processing” refers to processing that estimates one or more emotional states from the character data and/or the summary data, by analyzing lexical, syntactic, and contextual patterns in the text and optionally combining them with acoustic feature quantities.

The term “emotion score” refers to one or more numerical values indicating intensities of respective emotional states, such as fear, anger, anxiety, joy, sadness, or calmness, calculated based on the acoustic feature quantities and results of the emotion analysis processing. The term “emotion abnormality degree” refers to a numerical indicator representing a deviation of the emotion score over time from a reference state, including at least a magnitude of change or a rate of change of the emotion score within a predetermined time window. The term “abnormality determination conditions” refers to a set of rules, thresholds, models, or other conditions stored in a storage device, the conditions being used to determine presence or absence of abnormal events and a risk level based on at least the summary data, the important words, the emotion score, and the emotion abnormality degree.

The term “risk level” refers to a discrete or continuous indicator representing a degree of risk that an abnormal event such as fraud, violence, or theft is occurring or will occur, the indicator being determined by evaluating the abnormality determination conditions. The term “notification level” refers to a classification of urgency or priority of a warning message, determined based on at least the risk level and the emotion score, and used to control timing, modality, and detail of notifications.

The term “notification destination” refers to a recipient entity to which a warning message is transmitted, including at least a security manager, a facility manager, a related person, or an external organization registered in advance in the system.

The term “warning message” refers to text or multimedia content generated by the system that describes an abnormality or risk, including information such as a location, a type of suspected incident, an urgency, and recommended response actions.

The term “generative AI model” refers to a machine learning model, typically a neural network trained on large datasets, that generates text or other data in response to input data and instructions, and that is capable of performing tasks such as transcription, summarization, emotion estimation, risk evaluation, and message generation.

The term “prompt sentence” refers to a text string that instructs the generative AI model to perform a specific task or to output data in a specific format, including at least instructions for converting audio data into character data, generating summary data, evaluating a risk level, or generating a warning message.

The term “instruction information” refers to data input to the generative AI model that includes at least one prompt sentence and optionally context data such as audio data, character data, summary data, emotion scores, or risk levels, thereby defining the processing to be executed by the generative AI model.

The term “response result” refers to output data generated by the generative AI model in response to the instruction information, including at least transcribed text, summary text, evaluated risk labels or scores, or generated warning messages.

The term “rule engine” refers to a software component that evaluates logical rules contained in the abnormality determination conditions against input facts derived from the summary data, important words, emotion scores, and emotion abnormality degrees, and outputs intermediate or final abnormality determinations.

The term “machine learning model” refers to a computational model trained on example data to map input feature quantities, including at least summary data representations, important word indicators, emotion scores, and emotion abnormality degrees, to outputs such as abnormality occurrence probabilities or incident categories.

The term “communication line” refers to a wired or wireless communication medium, including at least public or private networks, through which audio signals or warning messages are transmitted between a terminal device, the server, and notification destinations. The term “communication network” refers to an interconnected infrastructure including communication lines and network equipment that allows the server to send and receive data, including at least audio data, character data, and warning messages, to and from external devices or systems.

The term “storage device” refers to a memory or storage apparatus, such as a semiconductor memory, magnetic disk, or optical storage, used to store programs, abnormality determination conditions, intermediate processing results, and log data in the server.

The term “security manager” refers to a person or system responsible for monitoring and responding to security incidents within a facility, and designated as a notification destination for warning messages.

The term “external organization” refers to an entity outside the monitored facility, such as a security service provider or a public safety organization, that can receive warning messages and take corresponding actions.

In the following embodiments, server, terminal, and user are used as main actors implementing the invention. Each embodiment is presented as an example and does not limit the scope of the claims.

### 1. Overall Hardware and Software Configuration

Server is implemented as an information processing apparatus including at least one central processing unit (CPU), a main memory, a non-volatile storage device, and a network interface. Server operates under a general-purpose operating system such as a UNIX-type OS and executes middleware components including a web server process, an application server process, a database management process, and an AI inference process.

Server uses a web server program such as a general HTTP server to terminate HTTPS connections from terminal. Server uses an application framework such as a general web application framework running in an interpreter or runtime environment (for example, a scripting language runtime or a virtual machine) to implement business logic including acoustic processing, natural language processing (NLP), emotion recognition, anomaly detection, and notification control. Server uses a database management system such as a relational database or a document-oriented database to store character data, summary data, acoustic feature quantities, emotion scores, risk levels, and log data.

Terminal is implemented as a portable or fixed information processing apparatus, such as a mobile communication device, a tablet device, or a dedicated monitoring device integrated with a network-connected camera. Terminal includes at least a CPU or system-on-chip, a memory, a microphone, a display, and a wireless or wired communication module. Terminal operates under an operating system such as a mobile operating system and uses audio acquisition APIs provided by the operating system.

User is a human operator or facility personnel who receives warning messages and takes real-world actions. User may also include a family member of a monitored person who receives recipient-specific notifications.

### 2. Audio Acquisition and Pre-Processing at the Terminal

Terminal uses its built-in microphone to continuously acquire environmental sounds and conversations in a monitored facility. Terminal calls an audio acquisition interface, such as a low-level audio recording API of the operating system, to sample analog audio at a sampling frequency of, for example, 16 kHz or 48 kHz and to quantize samples into 16-bit pulse code modulation (PCM) values.

Terminal stores the PCM samples in a circular buffer in memory and segments the samples into frames of a fixed duration, such as 1 to 3 seconds. Terminal associates each frame with metadata including at least a timestamp, a geographic location (for example, obtained by a position information module), and a device identifier.

Terminal uses an embedded signal processing library, such as an audio processing library implementing noise suppression and echo cancellation algorithms, to process each PCM frame. The noise suppression algorithm uses a statistical noise estimator that computes a noise spectrum in non-speech segments and subtracts or attenuates the noise spectrum from the current frame, resulting in a reduced-noise spectrum. The echo cancellation algorithm uses an adaptive filter that models the echo path from the device speaker to the microphone and subtracts the estimated echo component from the microphone signal. These algorithms reduce background noise and reverberation, and thus improve the signal-to-noise ratio before transmission.

Terminal uses an audio coding library such as an implementation of an adaptive transform-based codec (for example, an Opus-type codec) to compress the noise-reduced PCM frames. Terminal invokes an encoder function with parameters including sampling rate, frame size, and target bit-rate, and obtains a compressed byte stream suitable for real-time transmission over a network.

Terminal packages the compressed frame together with metadata into a message structure and transmits the message to server over a secure communication channel using a protocol such as HTTPS. Terminal may adjust transmission parameters (for example, reducing bit-rate or frame frequency) under control of a transmission control algorithm when network bandwidth becomes limited, thereby lowering communication load while maintaining intelligible speech.

### 3. Audio Decoding and Speech Recognition at the Server

Server receives the compressed audio messages via the network interface and passes them to the application server. Server uses a decoding library corresponding to the codec used at terminal to convert the compressed byte stream back into PCM audio data. Server reconstructs time-aligned audio segments by combining consecutive frames based on timestamps and session identifiers.

Server applies acoustic signal processing algorithms in a more computationally intensive configuration than those available at terminal. For example, server further applies spectral subtraction, Wiener filtering, or multi-band noise suppression algorithms to refine the signal quality. In certain embodiments, server uses beamforming with signals from multiple terminals to enhance speech from a specific spatial direction.

Server uses a speech recognition engine such as a hidden Markov model (HMM) or neural network-based recognizer to convert the PCM audio into character data. For example, server may use a model having an acoustic model implemented as a deep neural network (DNN) or time-delay neural network (TDNN), with an output layer representing phonetic or subword units, and a language model implemented as an n-gram or recurrent neural network (RNN). Server feeds acoustic feature vectors (for example, Mel-frequency cepstral coefficients and pitch features) extracted from the PCM frames into the acoustic model and uses a decoding algorithm such as a Viterbi search or beam search to produce the most likely word sequence. Server, in another embodiment, uses an end-to-end neural speech recognition model, such as a sequence-to-sequence model with an attention mechanism or a connectionist temporal classification (CTC) model. The model consists of layers such as convolutional layers, long short-term memory (LSTM) layers, or transformer encoder layers, and outputs character sequences directly from the acoustic features. Server selects the recognized sequence with the highest decoding probability and treats it as character data.

Server stores the recognized character data in the database together with segment identifiers, timestamps, and location information. By storing these data in a structured schema, server later performs time-aligned fusion with emotion analysis and anomaly detection results, which improves traceability and facilitates offline retraining.

### 4. Natural Language Processing and Generation of Summary Data

Server executes natural language processing on the character data. Server uses a morphological analyzer to segment character data into morphemes and to assign part-of-speech tags and base forms. The analyzer uses a lexicon and a statistical model (for example, a conditional random field) to determine the most likely segmentation and tagging. Server uses a syntactic parser to compute dependency relations among morphemes. The parser may use graph-based or transition-based algorithms to derive syntactic trees, which include subject-predicate and predicate-object relations. These structures are stored as parse trees or dependency graphs.

Server computes importance scores for words and phrases using methods such as term frequency-inverse document frequency (TF-IDF) or a graph-based ranking algorithm (for example, TextRank). For TF-IDF, server maintains document frequency statistics over a large corpus of recent conversations and calculates scores for each term in the current document. For TextRank, server constructs a graph whose nodes are words or sentences and whose edges represent co-occurrence or similarity; the algorithm iteratively updates node scores until convergence.

Server selects important words related to potential abnormal events by comparing candidate words against a stored lexicon of risk-related concepts (for example, words related to danger, violence, monetary transfer, threats, or calls for help) and by filtering via the computed importance scores. Server generates a list of important words with their scores and associations to conversation segments.

Server uses a generative AI model to generate summary data. The generative AI model is implemented, for example, as a large transformer-based language model with multiple self-attention layers, trained on a large corpus of text for a masked-language modeling and next-token prediction objective. The model parameters include weight matrices for attention projections, feed-forward layers, and layer normalization parameters.

Server constructs a prompt sentence that instructs the generative AI model to summarize the conversation, such as:

“This is a transcription of a conversation. Identify the important words and generate a concise summary of the conversation. Clearly indicate if the conversation involves danger, harm, monetary requests, or violent behavior.”

Server concatenates the prompt sentence and the character data into an input sequence and supplies the sequence to the generative AI model via an inference API. The model processes the input tokens through its transformer layers, computing self-attention over the tokens and producing contextualized embeddings. A language modeling head decodes these embeddings into a sequence of output tokens representing the summary. The model uses its learned parameters and beam search or sampling to select a coherent and relevant summary. Server receives the generated summary text and stores it as summary data. Server may also perform post-processing, such as normalizing terminology, truncating overly long outputs, or aligning sentences to specific conversation segments. By delegating summarization to the generative AI model under explicit prompt control, server reduces processing time compared to rule-based summarization and achieves higher recall for subtle risk indicators, thereby improving the computer's overall recognition performance.

### 5. Acoustic Feature Extraction and Emotion Recognition

Server computes acoustic feature quantities from the PCM audio. Server uses a signal processing library to calculate features such as short-time energy, spectral centroid, spectral bandwidth, zero-crossing rate, Mel-frequency cepstral coefficients, and pitch (fundamental frequency F0) for each analysis frame. Server normalizes these features using techniques such as mean-variance normalization or cepstral mean normalization to reduce channel and device variability.

Server uses a neural emotion classifier to estimate emotion scores. The classifier, in one embodiment, is a multi-layer neural network that receives, as input, a sequence of acoustic feature vectors and outputs probabilities over emotion categories such as fear, anger, anxiety, joy, sadness, and calmness. The network may consist of several layers of bidirectional LSTM units or transformer encoder layers that model temporal dependencies, followed by a pooling layer (for example, attention or average pooling) and a fully connected output layer with a softmax activation.

Server trains this classifier offline using supervised learning on labeled emotional speech datasets. The loss function can be cross-entropy between predicted probabilities and ground truth emotion labels. Server uses a gradient-based optimizer such as stochastic gradient descent or Adam to update weights. Data augmentation methods such as additive noise, time-stretching, and pitch-shifting are used during training to improve robustness.

Server also computes text-based emotion features. Server uses a language model (for example, a BERT-type encoder) to convert each sentence or segment of character data into a dense embedding vector. A separate neural classifier maps these embeddings to emotion probabilities or regression scores for each emotion category.

Server integrates acoustic and text-based emotion estimates using a multimodal fusion network. In one embodiment, server concatenates acoustic emotion probabilities and text-based emotion probabilities and feeds them into a small fully connected network trained to output calibrated emotion scores. In another embodiment, server uses a joint model that processes both acoustic and text features in parallel and fuses them via cross-attention layers. Server computes emotion scores as numerical values in a range, for example [0, 1], for each emotion category. Server then calculates emotion abnormality degree by analyzing temporal variations of the emotion scores. For instance, server applies a sliding window over the last several minutes and computes statistics such as standard deviation, derivative (difference between successive windows), and maximum deviation from a baseline estimated from historical data. These quantities are combined into an emotion abnormality index by a learned function or by heuristic rules.

By explicitly computing these indices, server can detect unusual emotional patterns such as sudden spikes in fear or sustained high anxiety, even when the text alone is ambiguous. This integrated use of temporal emotion patterns improves anomaly detection accuracy and reduces both false positives and false negatives, achieving a technical improvement in the machine's decision-making process compared to conventional, static keyword-based methods.

### 6. Abnormality Determination Using Rules, Machine Learning, and Generative AI

Server performs abnormality determination by evaluating abnormality determination conditions that incorporate summary data, important words, emotion scores, and emotion abnormality degrees.

Server first uses a rule engine that represents each rule as a pattern over facts, where facts include presence or absence of certain important words, ranges of emotion scores, values of emotion abnormality degrees, and semantic categories derived from the summary. The rule engine matches facts against conditions using an efficient algorithm (for example, a RETE algorithm) and triggers rule actions such as setting preliminary risk flags or assigning candidate incident categories.

Server also uses a machine learning model for predicting abnormality occurrence probability. In one embodiment, the model is a gradient-boosted decision tree or random forest that takes feature vectors constructed from:
numerical embeddings of summary data,
binary indicators for each important word or word category,
emotion scores for each emotion,
emotion abnormality indices, and
contextual features such as time of day or location category.

The model outputs a continuous probability value representing the likelihood of an abnormal event. In another embodiment, server uses a deep neural network classifier based on fully connected layers or transformer layers receiving the concatenated features and outputting class probabilities for multiple incident types including fraud, violence, and theft. Server computes the risk level by mapping the abnormality probability and the rule engine's outputs into discrete levels (for example, low, medium, high) using thresholds determined during system tuning. Server may also apply a calibration model to align predicted probabilities with observed frequencies from historical data, thereby improving the reliability of the numeric risk scores.

Server further uses the generative AI model as an auxiliary evaluator. Server constructs a prompt sentence that describes the situation using summary data and emotion scores, such as: “Based on the following conversation summary and emotion scores (for example, fear 0.85, anger 0.25, anxiety 0.70), evaluate the risk that this situation will develop into fraud, violence, theft, or another type of trouble. Rate the overall risk as low, medium, or high, and explain your reasoning in 2-3 sentences.”

Server submits this prompt and the summary to the generative AI model. The model encodes the text via its transformer layers and generates an output sequence containing a qualitative risk rating and an explanation. Server parses the output to extract the risk label (low/medium/high) and converts it to a numeric value. Server combines the model's assessment with the machine learning model's output, for example by taking a weighted sum or by inputting both into a small fusion network, to correct or refine the final risk level. This architecture does more than simply automate human judgment: server implements computational patterns that leverage high-dimensional embeddings, probabilistic models, and rule-based reasoning to exploit correlations across modalities and over time, achieving improved detection accuracy and robustness unattainable by simple manual review or naive automation. The explicit and structured use of prompt sentences ensures that the generative AI model produces outputs tailored to the internal decision logic, which directly improves computational performance.

### 7. Generation and Routing of Warning Messages

Server determines a notification level and a notification destination based on the final risk level, the emotion scores, and the emotion abnormality degree. Server uses a notification policy model that maps combinations of risk level and emotional intensity to notification levels (for example, informational, urgent, critical) and to recipient categories (for example, on-site security, remote monitoring center, family contact, external security organization). Server generates warning messages in a recipient-specific manner. For security-oriented notifications, server constructs a prompt sentence that instructs the generative AI model to generate a concise, operationally focused message, such as:

“Using the following information (conversation summary, emotion scores, detected keywords, incident location, and risk level), create a warning message for security staff. The message must clearly state: incident location, likely type of incident, urgency level, and recommended response actions. Use clear, concise, and formal operational language.” Server supplies this prompt along with structured data describing the incident. The generative AI model produces a text summarizing the incident, specifying the location, the type of suspected event, the urgency, and specific recommended steps. Server may apply post-processing, such as template wrapping, to place the generated text into a standardized notification format with identifiers, timestamps, and links to additional data.

For family-oriented notifications, server constructs a different prompt sentence, such as: “Using the following information (conversation summary, emotion scores, and risk level), create a notification message for the user's family. The message should avoid causing excessive anxiety, but it should politely convey that the user may currently be under strong stress or potential danger. Include recommended actions such as contacting the user or calling the facility for confirmation.”

Server similarly sends this prompt and the context to the generative AI model and receives a softer, more reassuring message. Server uses configuration data to select communication channels, for example, mobile push notifications, email, or messaging services, and transmits the warning messages to the selected notification destinations.

By separating notification levels and crafting messages through a generative AI model under explicitly controlled prompts, server optimizes communication bandwidth and human attention: less critical alerts can be delivered with minimal detail, while critical alerts include precise instructions, reducing response time and error rates.

### 8. Learning and Improvement of Models

Server maintains and improves its models over time. Server logs input features (audio statistics, character data, summary data, emotion scores, important words) and outputs (risk levels, emitted warnings, recipient responses). When user provides feedback (for example, confirming that an alert was a false positive or that an incident actually occurred), server stores this feedback as ground truth labels.

Server periodically re-trains the machine learning models using this feedback. For the anomaly classifier, server updates model parameters by minimizing a loss function such as cross-entropy between predicted probabilities and true labels. Server may perform hyperparameter search on tree depth, learning rates, or network width using validation data, and deploy the updated model after confirming improved performance metrics such as F1 score and calibration error.

For the emotion recognition models, server may fine-tune the neural network parameters on newly collected data exhibiting facility-specific acoustic conditions or language use, again using gradient-based optimization. Data augmentation strategies can be applied to simulate various noise conditions and speaking styles, which leads to more robust emotion detection and reduces overfitting.

Server may also adjust prompt sentences and their templates based on observed performance of the generative AI model. If certain prompts systematically produce over-cautious or under-responsive outputs, server can change wording, add constraints (for example, “do not classify as high risk unless both fear and anxiety exceed 0.7”), or supply more structured context to guide the model. In this way, the combination of conventional models, rule-based logic, and prompt-controlled generative AI models forms a closed-loop system that improves over time.

### 9. Technical Effects and Alternative Embodiments

The described system yields several technical effects in the operation of computer resources, beyond generic automation of human decision-making:
By performing noise reduction and echo cancellation at terminal and more advanced acoustic processing at server, the system reduces transmission bandwidth and improves input signal quality, which directly enhances recognition accuracy and computational efficiency.
By integrating multi-modal features (acoustic features, linguistic structures, and temporal emotion dynamics) inside server, the system reduces the computational burden of manual rule design and achieves higher detection precision through learned, high-dimensional decision boundaries.
By using a generative AI model with explicit prompt sentences as part of the core pipeline, the system leverages complex language modeling to produce summaries and risk evaluations that conventional rule-based systems cannot match, enabling more accurate and faster internal processing.
By structuring data into time-aligned records and employing rule engines and machine learning models optimized for those data structures, server improves data management and facilitates scalable, efficient anomaly detection in large-scale deployments.

In an alternative embodiment, server is distributed across multiple physical machines, where one machine performs high-throughput audio decoding and feature extraction, another performs NLP and emotion recognition, and a third hosts the generative AI model inference service. Inter-process communication between these machines uses message queues or remote procedure calls with standardized data schemas, which allows load balancing and horizontal scaling.

In another embodiment, terminal includes limited local models for simple keyword spotting or basic emotion cues (for example, high loudness and high pitch), and may initiate a high-priority transmission or local display of a notification when it detects a likely urgent event, even before server completes detailed analysis. This early stage detection reduces end-to-end response time and supports edge-cloud cooperation.

In another embodiment, server uses different generative AI models for different tasks: a speech-to-text model for transcription, a summarization-optimized model for generating summary data, and a classification-oriented model for textual risk analysis. Server routes data to these models selectively, based on context and resource availability, which optimizes inference latency and resource consumption.

Through these embodiments, server, terminal, and user cooperate in a technically structured way to realize the claimed system, and the computer architecture and algorithms are improved in terms of recognition accuracy, robustness to noise and emotional variation, data management, and risk-aware notification behavior.

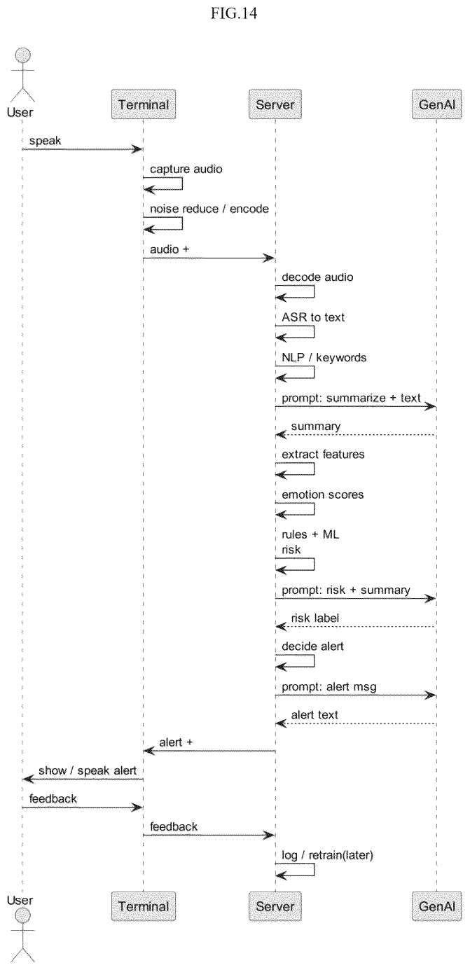

The following describes the processing flow using FIG. 14.

### Step 1:

Terminal acquires analog audio from a microphone and converts it into digital audio frames. Terminal receives, as input, an analog audio signal representing environmental sounds and conversations in a monitored area. Terminal calls an audio recording API of the operating system to sample the analog signal at a predetermined sampling rate (for example, 16 kHz or 48 kHz) and quantizes the samples into 16-bit PCM values. Terminal segments the continuous PCM stream into frames of fixed duration (for example, 1-3 seconds) and stores each frame in a buffer in main memory. Terminal attaches, as metadata, a timestamp from an internal clock, a device identifier, and position information obtained from a location module. The output of this step is a sequence of PCM audio frames, each associated with metadata including time, device ID, and location.

### Step 2:

Terminal applies local noise reduction and compression to prepare audio frames for transmission.

Terminal receives, as input, the PCM audio frames and their metadata generated in Step 1. Terminal calls a local audio processing library to perform noise suppression and echo cancellation on each PCM frame. Terminal computes a short-time spectrum, estimates a noise spectrum from non-speech regions, and attenuates noise components to produce a noise-reduced PCM frame. Terminal uses an adaptive filter to estimate and subtract an echo component if a loudspeaker is active. Terminal then invokes an audio codec library to encode each noise-reduced PCM frame into a compressed format, specifying encoder parameters such as target bit-rate and frame size. Terminal packages the compressed byte array together with the original metadata into a transmission packet and sends the packet to server via an HTTPS connection. The output of this step is a stream of compressed audio packets with attached metadata transmitted to server.

### Step 3:

Server decodes compressed audio packets and reconstructs time-aligned PCM audio segments.

Server receives, as input, compressed audio packets and metadata from terminal via a network interface. Server parses each packet to separate the compressed audio payload from the metadata (timestamp, device ID, location). Server calls a decoding library corresponding to the codec used at terminal to convert the compressed payload back into PCM samples. Server groups and concatenates decoded PCM frames in chronological order based on timestamps and device IDs, thereby reconstructing longer PCM audio segments representing continuous conversation windows. Server may apply additional filtering, such as spectral subtraction, to further improve signal quality. The output of this step is a set of time-aligned PCM audio segments with associated metadata for each monitored session.

### Step 4:

Server performs speech recognition to convert PCM audio segments into character data. Server receives, as input, the PCM audio segments and their metadata from Step 3. Server extracts acoustic feature vectors from each segment, such as Mel-frequency cepstral coefficients, energy, and pitch. Server feeds these feature sequences into a speech recognition engine that includes an acoustic model and a language model. The acoustic model computes likelihoods of phonetic units for each frame, and the language model computes probabilities of word sequences. Server runs a decoding algorithm (for example, a beam search) to find the most probable word or character sequence given the acoustic and language scores. In another configuration, server sends the audio segment and a prompt sentence to a generative AI model, for example: “Convert this audio data into accurate text. Remove or ignore background noise and clearly separate different speakers if possible.” The generative AI model processes the audio and prompt and returns transcribed text. Server selects the transcription result and associates it with the original timestamps and location. The output of this step is character data (recognized text) aligned with time and location metadata.

### Step 5:

Server executes morphological and syntactic analysis on character data to derive linguistic structure.

Server receives, as input, character data and associated metadata from Step 4. Server calls a morphological analyzer to segment the text into morphemes and assign part-of-speech tags and base forms to each morpheme. Server then calls a syntactic parser that uses the morphologically analyzed text to determine dependency relations among morphemes, identifying heads and dependents and labeling grammatical roles such as subject, object, and predicate. Server stores the resulting token sequence and dependency tree in an internal data structure linked to the original text segments. The output of this step is structured linguistic data, including token lists with tags and syntactic dependency graphs for each segment of character data.

### Step 6:

Server extracts important words related to risk from the linguistic data.

Server receives, as input, the tokenized text and dependency information from Step 5. Server computes term importance scores using at least one of term frequency-inverse document frequency (TF-IDF) and a graph-based ranking algorithm. For TF-IDF, server counts term frequencies in the current document and uses pre-stored document frequency statistics; for graph-based ranking, server constructs a word co-occurrence graph and iteratively updates node scores. Server compares candidate words and phrases against a stored lexicon of risk-related concepts (for example, terms related to danger, fraud, money transfer, threats, or calls for help) and filters them by importance scores and syntactic roles. Server outputs a list of important words, each associated with its position in the text, importance score, and semantic category. The output of this step is an important-word list linked to each conversation segment.

### Step 7:

Server generates summary data of conversations by calling a generative AI model with a prompt sentence.

Server receives, as input, the character data and important-word list from Steps 4 and 6. Server constructs a prompt sentence that instructs the generative AI model to summarize the conversation, for example: “Analyze the following conversation text and identify the important words. Then generate a concise summary of the conversation. Clearly indicate if the conversation involves danger, harm, monetary requests, or violent behavior.” Server concatenates the prompt sentence and the conversation text into a single input sequence and sends this sequence to the generative AI model via an inference API. The generative AI model performs tokenization, multi-layer transformer processing, and decoding to generate summary text. Server receives the output tokens, converts them to text, and associates the summary with the corresponding conversation session and metadata. The output of this step is summary data representing the main content of the conversation, emphasizing any risk-related elements.

### Step 8:

Server computes acoustic feature quantities and text embeddings for emotion recognition. Server receives, as input, the PCM audio segments from Step 3 and the character data and summary data from Steps 4 and 7. Server uses a signal processing library to extract acoustic feature quantities from each audio segment, including energy, spectral features, MFCCs, and pitch trajectories. Server normalizes these features across time and sessions. In parallel, server uses a language model to convert each text segment and summary into dense embedding vectors that capture semantic and contextual information. Server organizes both acoustic features and text embeddings into synchronized sequences keyed by time and session identifiers. The output of this step is a set of acoustic feature sequences and text embedding sequences ready for emotion analysis.

### Step 9:

Server estimates emotion scores and emotion abnormality degrees from multi-modal features. Server receives, as input, the acoustic feature sequences and text embeddings from Step 8. Server feeds the acoustic features into an acoustic emotion classifier, such as a neural network with recurrent layers, which outputs probabilities for multiple emotion categories (for example, fear, anger, anxiety, joy, sadness, calmness) for each segment. Server feeds the text embeddings into a text-based emotion classifier, which similarly outputs emotion probabilities based on lexical and contextual cues. Server combines the acoustic and text-based probabilities using a fusion network or weighted averaging to produce final emotion scores, represented as numeric values in a predetermined range for each emotion category. Server then evaluates temporal sequences of emotion scores within sliding windows, computing changes, deviations from baseline, and volatility measures. From these statistics, server calculates an emotion abnormality degree that quantifies how strongly the emotional pattern deviates from typical behavior. The output of this step is, for each segment, a set of emotion scores and an emotion abnormality degree with timestamps and session identifiers.

### Step 10:

Server determines abnormality and risk level using rules, a machine learning model, and a generative AI model.

Server receives, as input, the summary data from Step 7, the important words from Step 6, and the emotion scores and emotion abnormality degrees from Step 9. Server constructs a feature set including summary embeddings, binary indicators for important words, numerical emotion scores, and emotion abnormality indices. Server provides these features as facts to a rule engine implementing abnormality determination conditions. The rule engine evaluates configuration rules (for example, “if money-request terms are present and fear score exceeds a threshold, mark as suspected fraud”) and produces intermediate flags or preliminary risk categories. Server also inputs the feature vectors into a trained machine learning model, such as a random forest or neural network, which outputs an abnormality probability. Server maps this probability to a preliminary risk level (for example, low, medium, high). Additionally, server constructs a prompt sentence for the generative AI model, for example: “Based on the following conversation summary and emotion scores (for example, fear 0.85, anger 0.25, anxiety 0.70), evaluate the risk that this situation will develop into fraud, violence, theft, or another type of trouble. Rate the overall risk as low, medium, or high, and explain your reasoning in 2-3 sentences.” Server sends this prompt and the summary text to the generative AI model and receives a qualitative risk rating and explanation. Server converts the rating into a numeric value and combines it with the rule-based and machine-learning outputs, for example by computing a weighted sum or selecting the maximum. Server outputs a final risk level and a determination of presence or absence of abnormality for each conversation session. The output of this step is a labeled abnormality state and a numeric risk level with associated context.

### Step 11:

Server generates warning messages tailored to notification level and recipient type using prompt sentences.

Server receives, as input, the final risk level, abnormality state, emotion scores, emotion abnormality degrees, summary data, and metadata (such as location) from Step 10. Server determines a notification level (e.g., informational, warning, critical) and identifies one or more notification destinations (such as security staff or family members) based on a notification policy. For security staff, server constructs a prompt sentence, for example: “Using the following information (conversation summary, emotion scores, detected keywords, incident location, and risk level), create a warning message for security staff. The message must clearly state: incident location, likely type of incident, urgency level, and recommended response actions. Use clear, concise, and formal operational language.” Server formats the incident information as structured text and sends it with the prompt to the generative AI model. The generative AI model returns a message text containing the requested elements. For family members, server constructs a different prompt, for example: “Using the following information (conversation summary, emotion scores, and risk level), create a notification message for the user's family. The message should avoid causing excessive anxiety, but it should politely convey that the user may currently be under strong stress or potential danger. Include recommended actions such as contacting the user or calling the facility for confirmation.” Server sends the family-oriented prompt and context to the generative AI model and receives a correspondingly adapted message. The output of this step is a set of finalized warning messages, each tailored to a notification level and recipient type.

### Step 12:

Server delivers warning messages and logs notification events.

Server receives, as input, the finalized warning messages and their intended notification destinations from Step 11. Server selects appropriate communication channels for each destination, such as a push notification service for mobile devices, email via an SMTP server, or a messaging platform API. Server formats each warning message into a protocol-specific payload, including headers, timestamps, identifiers, and message body, and transmits the payload to the communication service. Server waits for delivery status responses and records success or failure along with timing information. Server writes a notification log entry into the database for each message, storing fields such as recipient type, channel used, message content, risk level, emotion summary, and delivery result. The output of this step is the actual transmission of warning messages to users and a persistent log of all notification activities.

### Step 13:

User receives warning messages and provides feedback for model improvement.

User receives, as input, warning messages on a terminal device such as a mobile phone, tablet, or monitoring console. User reads the incident description, location, risk level, and recommended response actions contained in the message. Based on this content, user executes real-world actions such as moving to the incident location, contacting involved persons, or calling external emergency services. User may also interact with a feedback interface provided by terminal or by a web application, where user indicates whether the alert reflected an actual incident or a false alarm and can optionally select an incident category. Terminal or client software packages this feedback data with references to the original alert and sends it to server. The output of this step is a set of human verification labels and qualitative comments that server can later use to retrain and refine the underlying models and rules.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

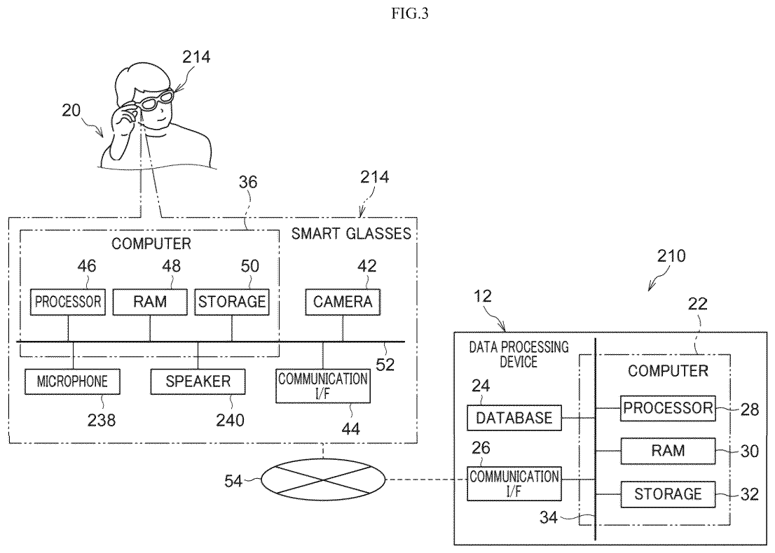

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

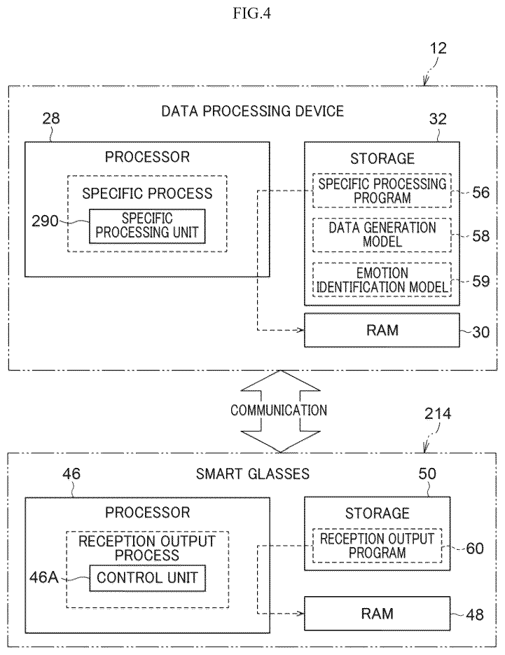

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

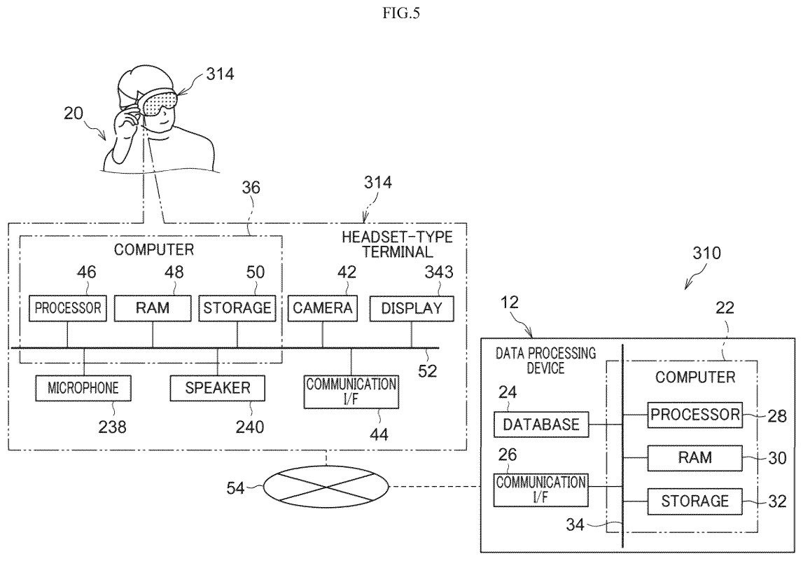

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

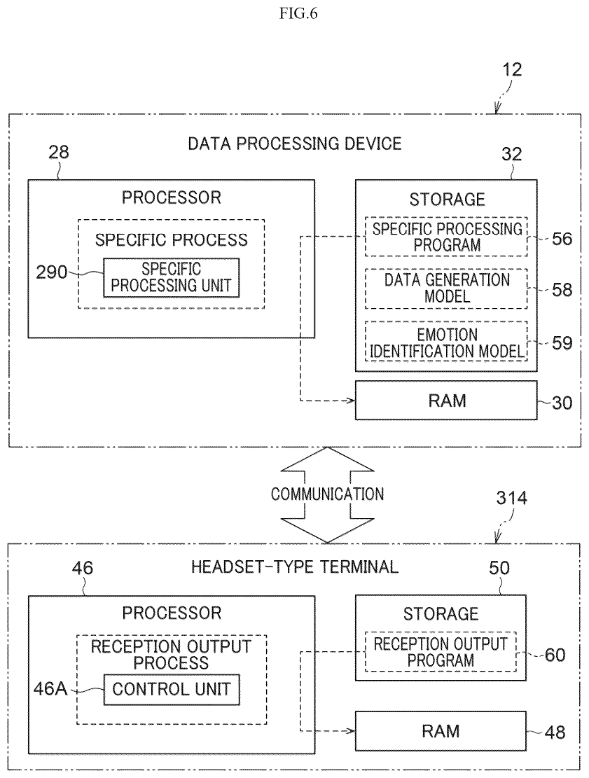

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

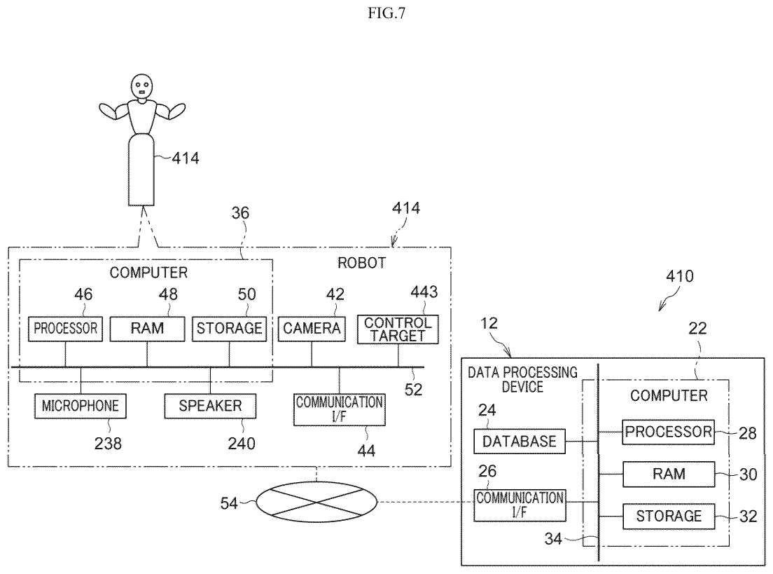

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

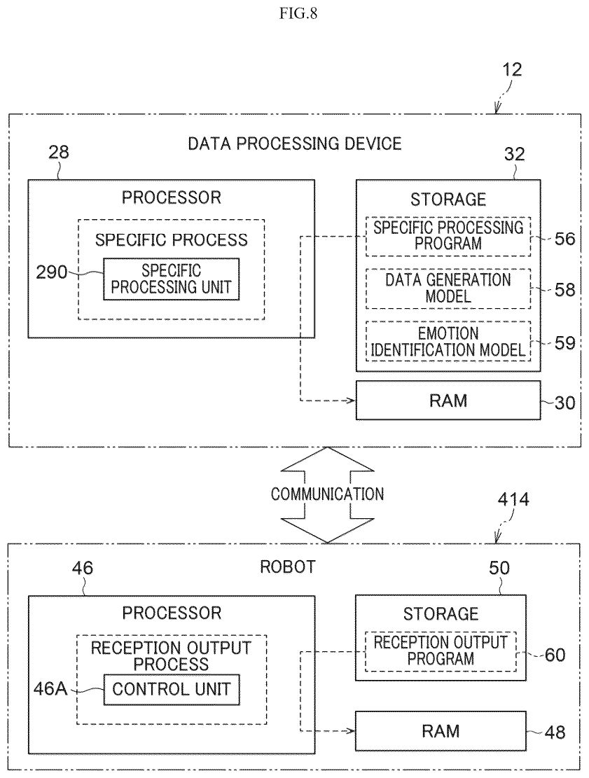

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

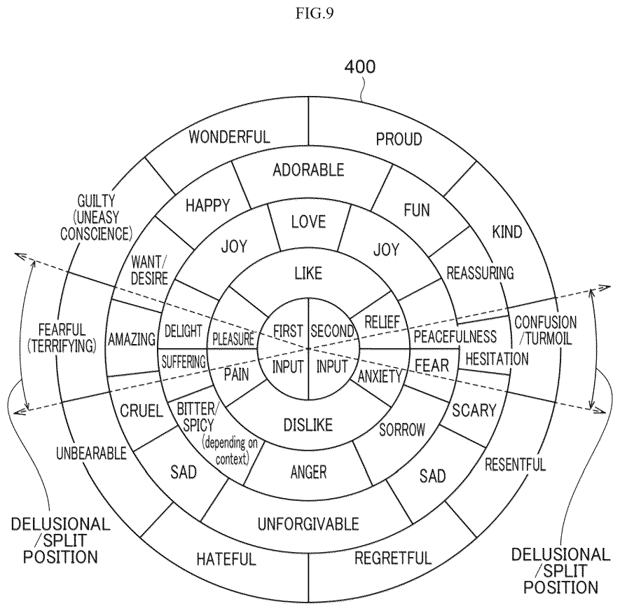

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

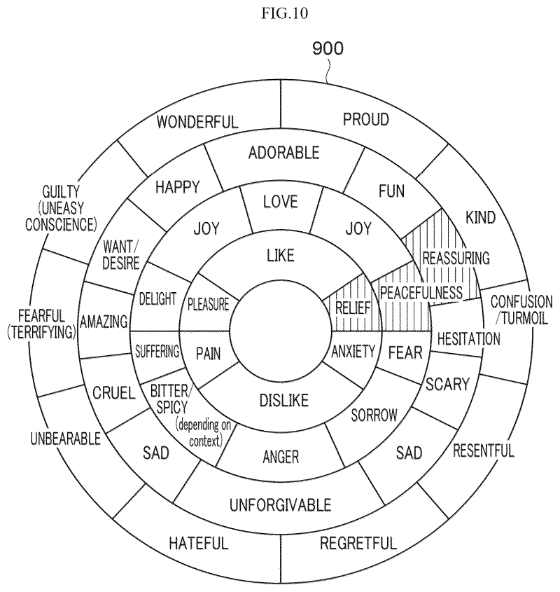

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire and preprocess a call voice signal,
convert the preprocessed call voice signal into text information,
analyze the text information to generate structured information and summary information,
determine a fraud risk on a basis of the structured information and the summary information,
generate and output warning information on a basis of the fraud risk,
generate a prompt sentence for a generative AI model by using at least one of the text information, the structured information, and the summary information as input information, and execute at least one of correction of the text information, generation of the structured information, generation of the summary information, generation of explanation information regarding the fraud risk, and generation of the warning information, by using the generative AI model and the prompt sentence,
present the warning information to a user terminal and transmit notification information based on the summary information and the fraud risk to at least one registered related-party terminal when the fraud risk satisfies a predetermined condition,
and control, in real time, exchange of the call voice signal, the text information, the structured information, the summary information, and the fraud risk among functional units in the system.

### (Supplementary 2)

The system according to supplementary 1,
wherein the processor is configured to
perform signal processing including noise reduction processing, reverberation suppression processing, and volume normalization processing on the call voice signal to reduce background noise and emphasize a speaker voice,
execute morphological analysis processing, syntactic analysis processing, sentiment analysis processing, and topic extraction processing on the text information to extract attribute information including monetary request information, payment condition information,
transaction party identification information, time information, and participant information as the structured information and to generate the summary information with priority on information related to monetary transfer,
combine rule-based processing based on fraud determination conditions and probability estimation processing based on a trained determination model to calculate a risk score and a risk category as the fraud risk,
and dynamically generate the prompt sentence for the generative AI model, the prompt sentence including at least one of: a prompt sentence for performing misrecognition correction and punctuation insertion on the text information obtained from the call voice signal, a prompt sentence for extracting important expressions and monetary conditions from the text information and generating the summary information, a prompt sentence for explaining reasons for a possibility of fraud on a basis of the structured information and the risk score, and a prompt sentence for generating a draft warning message to be transmitted to the user terminal and the registered related-party terminal, and input the prompt sentence to the generative AI model.

### (Supplementary 3)

The system according to supplementary 1,
wherein the processor is configured to
transmit the notification information based on the summary information and the fraud risk to the registered related-party terminal by using an electronic communication service via a communication device, the notification information including call time information, the summary information, the risk category, and recommended action information,
store feedback information acquired from the user terminal as learning data and update the trained determination model on a basis of the learning data,
and generate the prompt sentence for the generative AI model using explanation information regarding a new fraud method acquired from an external information source as input, the prompt sentence causing the generative AI model to generate determination rule information including detection keyword information, typical expression information, and context condition information, and update the fraud determination conditions on a basis of the determination rule information.

### Application Example 1

### (Supplementary 1)

A system comprising a processor,
wherein the processor is configured to convert an audio signal acquired via a communication path into digital data and extract audio information from the digital data,
perform noise reduction processing and reverberation suppression processing on the audio information to generate processed audio data in which audio features are emphasized, execute speech recognition processing on the processed audio data based on an acoustic model and a language model to generate text information including time information and reliability information,
perform morphological analysis processing, syntactic analysis processing, emotion analysis processing, and topic extraction processing on the text information to generate structured text information including important terms, emotion information, and topic information,
generate a prompt sentence for a generative AI model using the structured text information as input information, and execute the generative AI model with the prompt sentence to generate summary information of conversation content and abnormality-related information,
compare the summary information and the abnormality-related information with abnormality determination conditions stored in advance and with a determination model learned based on past cases, and generate abnormality determination information that classifies at least one of a normal state, a suspicious state, and an abnormal state,
generate warning information and tracking information according to the abnormality determination information and notify a user and a registered destination via at least one of a display device, an audio device, a portable terminal, a communication terminal, and a communication service, and
store, as record information, at least the audio signal, the text information, the structured text information, the summary information, the abnormality determination information, and a notification history, and execute learning processing to update the abnormality determination conditions and the determination model based on the record information.

### (Supplementary 2)

The system according to supplementary 1,
wherein the processor is configured to
generate the prompt sentence for the generative AI model including control information that defines an input format including conversation text, important terms, emotion information,
and topic information, and that defines an output format of the summary information of the conversation content in which at least who acts, where an action occurs, what is performed, and what kind of risk or suspiciousness is present are explicitly described,
and generate the abnormality determination information by generating feature values based on expression patterns included in the summary information, combinations of the important terms, the emotion information, and the topic information, inputting the feature values to a machine learning algorithm to calculate an abnormality index, and determining the normal state, the suspicious state, and the abnormal state based on the abnormality index and the abnormality determination conditions.

### (Supplementary 3)

The system according to supplementary 1,
wherein the processor is configured to
select, according to a state classification and the abnormality index included in the abnormality determination information, at least one combination of display output to a facility display device, voice warning output by an audio device, push notification output to the portable terminal, and communication output via an external communication service,
and execute the learning processing by periodically or conditionally performing retraining of the determination model using the notification history and a response result by the user as teacher information, and dynamically updating the abnormality determination conditions and the determination model in accordance with changes in abnormality patterns.

### Example 2

### (Supplementary 1)

A system comprising a processor,
wherein the processor is configured to
acquire an audio signal via a communication path, convert the audio signal into digital audio data, perform noise reduction processing on the digital audio data, and convert the noise-reduced audio data into text data by using a speech recognition function,
analyze the text data by executing morphological analysis and syntactic analysis, generate a conversation summary and a subject label including an expression related to a monetary request or an account information request by using a natural language processing function, extract acoustic feature quantities from the noise-reduced audio data, estimate a time-varying emotional state of a speaker during a call on the basis of the acoustic feature quantities and on the basis of at least one of the text data and the conversation summary by using an emotion recognition function,
calculate a fraud risk for each call by performing matching between the conversation summary, the subject label, and the time-varying emotional state, on the one hand, and a fraud determination condition and a trained determination model, on the other hand, input at least one of the text data and the conversation summary and a prompt sentence into a generative AI model, acquire a text output indicating an estimation of the fraud risk and a reason for the estimation from the generative AI model, and determine a fraud possibility of the call by integrating the fraud risk and the text output by using a fraud determination function,
determine, when the fraud risk is determined to be equal to or greater than a threshold by the fraud determination function, presence or absence of a warning, a warning strength, and presence or absence of a notification to a third party on the basis of the fraud risk and the emotional state, input the fraud risk, the emotional state, and a prompt sentence into the generative AI model, cause the generative AI model to automatically generate a warning message that takes into account a psychological state of a user, present the warning message by at least one of a display unit and an audio output unit of a terminal, and transmit a notification to a registered related party as needed by using a warning notification function, and acquire feedback information relating to an actual presence or absence of fraud of the call and relating to an appropriateness of warning content, the feedback information being input by the user after termination of the call, store the feedback information as learning data, and use the feedback information for a relearning process to update parameters of the trained determination model and parameters of the emotion recognition function by using a learning control function.

### (Supplementary 2)

The system according to supplementary 1,
wherein the processor is configured to
input the noise-reduced audio data and a prompt sentence instructing the generative AI model to ignore background noise and to accurately transcribe numerical information and account information into a speech recognition service operating on an external processing apparatus and using the generative AI model, and use a transcription result obtained as a response from the speech recognition service as the text data,
update the fraud determination condition and a weighting parameter by using a machine learning algorithm on the basis of at least one of the conversation summary, the subject label, the time-varying emotional state, and user feedback information, and
input a fraud risk level, an emotion label of the user, a desired writing style, and a message length into the generative AI model as the prompt sentence, acquire a warning message text as a response from the generative AI model, and output the warning message text as screen display data and speech synthesis data of the terminal.

### (Supplementary 3)

The system according to supplementary 1,
wherein the processor is configured to
generate, when the fraud risk and the emotional state satisfy a predetermined condition, a notification message including the conversation summary, the fraud risk, the emotional state, and action recommendation information, and automatically transmit the notification message to a registered third party via an electronic communication network,
and control the system to use, as the terminal, an information processing apparatus connected to a communication line, the information processing apparatus being externally attached to an existing call apparatus, acquire call audio in real time by the information processing apparatus, and operate in cooperation with an external processing apparatus including the speech recognition function, the natural language processing function, the emotion recognition function, and the fraud determination function.

### Application Example 2

### (Supplementary 1)

A system comprising a processor,
wherein the processor is configured to
receive an audio signal via a communication line, convert the audio signal into digital audio data, and perform acoustic signal processing including noise reduction processing and speech recognition processing on the audio data so as to convert the audio data into character data, analyze the character data by executing morphological analysis processing and syntactic analysis processing to extract, from among a plurality of words included in the character data, important words related to danger and monetary requests, and generate summary data of a conversation based on the character data,
extract acoustic feature quantities from the audio data, perform emotion analysis processing on the character data and the summary data, and calculate an emotion score indicating an emotional state of a speaker and an emotion abnormality degree indicating a temporal change of the emotional state, based on the acoustic feature quantities and a result of the emotion analysis processing,
compare the summary data and the important words with predetermined abnormality determination conditions stored in a storage unit for determining occurrence risks of abnormal events including fraud, violence, and theft, and evaluate the emotion score and the emotion abnormality degree by incorporating the emotion score and the emotion abnormality degree into the abnormality determination conditions so as to determine presence or absence of an abnormality or a risk level in the conversation corresponding to the audio signal, determine a notification level and a notification destination in accordance with the emotion score and the risk level when it is determined that an abnormality has occurred or the risk level is equal to or greater than a predetermined value, and generate a warning message based on content of the conversation and the emotional state and transmit the warning message to the notification destination, and
input instruction information including at least one prompt sentence to a generative AI model, the at least one prompt sentence including a prompt sentence for causing the generative AI model to convert the audio data into the character data, a prompt sentence for causing the generative AI model to generate the summary data from the character data, a prompt sentence for causing the generative AI model to evaluate the risk level based on the content of the conversation and the emotional state, and a prompt sentence for causing the generative AI model to generate the warning message, and use a response result from the generative AI model in at least a part of processing of the acoustic signal processing and the speech recognition processing, processing of the analysis of the character data and generation of the summary data, processing of recognition of the emotional state, and processing of generation and transmission of the warning message.

### (Supplementary 2)

The system according to supplementary 1,
wherein the processor is configured to
perform the acoustic signal processing by executing noise suppression processing and echo cancellation processing to reduce background noise and reverberation components of the audio data and to clarify a voice component of the speaker before executing the speech recognition processing,
generate the summary data by extracting the important words based on results of the morphological analysis processing and the syntactic analysis processing and calculating importance degrees of the words using a statistical method or a graph-based method,
calculate the risk level by using the abnormality determination conditions including a rule group executed by a rule engine and by calculating an abnormality occurrence probability using a machine learning model in which the summary data, the important words, the emotion score, and the emotion abnormality degree are used as feature quantities, and
input to the generative AI model, as the instruction information, the summary data and the emotion score together with a prompt sentence for risk evaluation and acquire an evaluation result corresponding to the risk level from the generative AI model and correct the risk level based on the evaluation result and an output of the machine learning model.

### (Supplementary 3)

The system according to supplementary 1,
wherein the processor is configured to
generate a plurality of types of notification messages including a notification for a security manager and a notification for a family member of a user in accordance with the risk level and the emotion score,
input, when generating the notification for the security manager, to the generative AI model information including the content of the conversation, the emotion score, the important words, an occurrence location, and the risk level together with a prompt sentence for causing the generative AI model to generate a text including at least an indication of the occurrence location, an assumed type of incident, an urgency, and recommended response actions,
input, when generating the notification for the family member, to the generative AI model information including the content of the conversation, the emotion score, and the risk level together with a prompt sentence for causing the generative AI model to generate a text that conveys, without causing excessive anxiety, a possibility that the user is under high stress or danger and that includes recommended actions for the family member, and
automatically transmit the warning message as the notification message to at least one notification destination among a security manager, a facility manager, a related person, and an external organization registered in advance.

What is claimed is:

1. A system comprising:
circuitry configured to:
receive, via a communication interface coupled to a packet-switched network, an audio signal representing a communication session;
convert the audio signal into text information;
analyze the text information to generate summary information of the communication session;
determine a risk level by comparing the summary information with predetermined determination conditions; and
generate warning information on a basis of the risk level and transmit the warning information to at least one of a user terminal and a registered related-party terminal via the packet-switched network.

2. The system according to claim 1, wherein the circuitry is further configured to analyze the text information by executing at least one of morphological analysis processing, syntactic analysis processing, sentiment analysis processing, and topic extraction processing to extract structured information comprising attribute information from the text information, and to generate the summary information on a basis of the structured information.

3. The system according to claim 2, wherein the attribute information comprises at least one of monetary request information, payment condition information, transaction party identification information, time information, and participant information.

4. The system according to claim 3, wherein the circuitry extracts the attribute information by executing a named entity recognition model comprising at least one of a neural network using bidirectional long short-term memory layers and a conditional random field layer, and a transformer-based token classifier, to identify entity spans comprising at least one of person references, organization references, monetary amounts, and time expressions.

5. The system according to claim 4, wherein the circuitry is further configured to construct a prompt sentence instructing a generative AI model to extract entities and label utterances by topic and emotional tone from the text information, input the prompt sentence and the text information to the generative AI model, receive response information, and integrate the response information with the attribute information extracted by the named entity recognition model.

6. The system according to claim 1, wherein the circuitry is further configured to determine the risk level by combining rule-based processing that evaluates the summary information against the predetermined determination conditions to generate risk flags, and probability estimation processing that inputs a feature vector derived from the summary information to a trained determination model to calculate a risk score, and mapping a combined result of the rule-based processing and the probability estimation processing to a risk category.

7. The system according to claim 6, wherein the trained determination model comprises at least one of a gradient boosting machine, a random forest, and a neural network classifier comprising fully connected layers with rectified linear unit activations and a sigmoid output, the trained determination model having been trained on labeled historical data using a binary cross-entropy loss function and gradient-based optimization.

8. The system according to claim 7, wherein the circuitry is further configured to construct a prompt sentence including the summary information, the attribute information, the risk score, and triggered rules, transmit the prompt sentence to a generative AI model, and receive explanation information describing reasons and contributing factors underlying the risk level in a form understandable to a human user.

9. The system according to claim 1, wherein the circuitry is further configured to transmit the warning information to the user terminal, the warning information comprising a warning message for display on the user terminal and audio data generated by a text-to-speech engine for output through a speaker of the user terminal.

10. The system according to claim 9, wherein the circuitry is further configured to transmit notification information to the registered related-party terminal via an electronic communication service when the risk level satisfies a predetermined threshold, the notification information comprising at least call time information, the summary information, the risk category, and recommended action information.

11. The system according to claim 10, wherein the communication session comprises a telephone call, the predetermined determination conditions comprise fraud determination conditions, and the registered related-party terminal is associated with at least one of a family member, a friend, and a security organization registered in advance by a user.

12. The system according to claim 1, wherein the circuitry is further configured to construct a prompt sentence instructing a generative AI model to correct recognition errors and insert punctuation in the text information, input the prompt sentence and the text information to the generative AI model, receive corrected text information, and replace the text information with the corrected text information for subsequent analysis.

13. The system according to claim 12, wherein the circuitry is further configured to preprocess the audio signal prior to converting the audio signal into the text information by performing at least one of noise reduction processing, reverberation suppression processing, and volume normalization processing.

14. The system according to claim 1, wherein the circuitry is further configured to receive feedback information from the user terminal indicating whether the risk level determination was correct, store the feedback information as learning data, and update the trained determination model on a basis of the learning data.

15. The system according to claim 14, wherein the circuitry is further configured to acquire description information regarding a new risk pattern from an external information source, construct a prompt sentence including the description information, transmit the prompt sentence to a generative AI model, receive determination rule information comprising at least detection keyword information, typical expression information, and context condition information, and update the predetermined determination conditions on a basis of the determination rule information.

16. The system according to claim 1, wherein the circuitry is further configured to estimate an emotion of a user by applying an emotion identification model to at least one of acoustic feature data derived from the audio signal, facial expression data extracted from image information, and text sentiment data derived from the text information, and to include an emotion state indicator in the warning information.

17. The system according to claim 1, wherein the circuitry is further configured to convert the audio signal into the text information by extracting acoustic features comprising log-mel filter bank features, inputting the acoustic features to a neural network comprising a convolutional front-end and a plurality of transformer encoder layers, and decoding hidden representations into token sequences using beam search constrained by a language model.

18. A system comprising:
circuitry configured to:
receive, via a communication interface operating over a packet-switched network, an audio signal representing a communication session, and preprocess the audio signal by performing noise reduction processing, reverberation suppression processing, and volume normalization processing;
convert the preprocessed audio signal into text information by extracting acoustic features comprising log-mel filter bank features, inputting the acoustic features to a neural network comprising a convolutional front-end and transformer encoder layers, and decoding token sequences using beam search constrained by a language model;
construct a first prompt sentence instructing a generative AI model to correct recognition errors and insert punctuation in the text information, input the first prompt sentence and the text information to the generative AI model, and obtain corrected text information;
analyze the corrected text information by executing morphological analysis processing, syntactic analysis processing, sentiment analysis processing, and topic extraction processing to extract structured information comprising attribute information, and generate summary information on a basis of the structured information;
determine a risk level by combining rule-based processing that evaluates the structured information and the summary information against predetermined determination conditions, and probability estimation processing that inputs a feature vector to a trained determination model to calculate a risk score, and mapping a combined result to a risk category;
construct a second prompt sentence including the summary information, the attribute information, and the risk score, transmit the second prompt sentence to the generative AI model, and receive explanation information regarding the risk level;
generate warning information comprising the explanation information and transmit the warning information to a user terminal via the packet-switched network, and transmit notification information comprising the summary information, the risk category, and recommended action information to a registered related-party terminal via the packet-switched network; and
receive feedback information from the user terminal and update the trained determination model on a basis of the feedback information.

19. The system according to claim 18, wherein the circuitry is further configured to estimate an emotion of a user by applying an emotion identification model to at least one of acoustic feature data derived from the audio signal and text sentiment data derived from the corrected text information, and to adjust at least one of a priority and a presentation format of the warning information on a basis of the estimated emotion.

20. A method performed by circuitry of a system, the method comprising:
receiving, via a communication interface coupled to a packet-switched network, an audio signal representing a communication session;
converting the audio signal into text information;
analyzing the text information to generate summary information of the communication session;
determining a risk level by comparing the summary information with predetermined determination conditions; and
generating warning information on a basis of the risk level and transmitting the warning information to at least one of a user terminal and a registered related-party terminal via the packet-switched network.
